(19) United States
(12) Patent Application Publication
(10) Pub. No.: US 2017/0362431 A1
(43) Pub. Date: Dec. 21, 2017

(54) COPOLYCARBONATE COMPOSITIONS WITH IMPROVED RHEOLOGICAL AND OPTICAL PROPERTIES CONTAINING DIGLYCEROLESTERS

(71) Applicant: Covestro Deutschland AG, Leverkusen (DE)

(72) Inventors: Rolf WEHRMANN, Krefeld (DE); Helmut Werner HEUERü, Leverkusen (DE); Anke BOUMANS, Goch (DE)

(21) Appl. No.: 15/532,198

(22) PCT Filed: Nov. 26, 2015
(86) PCT No.: PCT/EP2015/077727

§ 371 Date: Jun. 1, 2017

(30) Foreign Application Priority Data
Dec. 1, 2014 (EP) 14195716.7

(51) Int. Cl. C08L 69/00; C08K 5/103; C08K 5/521

(52) U.S. Cl. CPC C08L 69/00; C08K 5/521; C08K 5/103; C08L 2205/02

(57) ABSTRACT

The invention relates to copolycarbonate compositions containing diglycerolesters, which have improved rheological as well as optical properties, to their use for producing blends, mouldings and to moldings obtained therewith.

The invention relates to copolycarbonate compositions comprising carboxylic esters of diglycerol which exhibit both improved rheological and optical properties, to the use thereof for producing blends, moldings and to moldings obtainable therefrom.

Copolycarbonates belong to the group of technical thermoplastics. They find versatile applications in the electrical and electronics sector, as a housing material of lamps and in applications where particular thermal and mechanical properties are required, for example hairdryers, applications in the automobile sector, plastic covers, reflectors, diffusers or light conducting elements and lamp covers or lamp bezels. These copolycarbonates may be used as blend partners for further thermoplastic plastics materials.

In these compositions good thermal and mechanical properties such as a high Vicat temperature (heat distortion resistance) and glass transition temperature are practically always compulsory. However, at the same time high glass transition temperatures and heat distortion resistances also result in relatively high melt viscosities which in turn has a negative effect on processability, for example in injection molding.

The flowability of (co)polycarbonate compositions/(co)PC blends can be increased by the addition of low molecular weight compounds. Since substances of this kind, however, simultaneously act as plasticizers, they lower the heat distortion resistance and glass transition temperature of the polymer matrix. This in turn is undesirable, since this reduces the temperature use range of the materials.

DE 102004020673 describes copolycarbonates having improved flowability based on bisphenols having an ether/thioether linkage.

DE 3918406 discloses blends for optical data storage means, based on a specific polycarbonate with elastomers or other thermoplastics and the use thereof in optical applications, specifically optical data storage means such as compact discs.

EP 0 953 605 describes linear polycarbonate compositions having improved flow characteristics, characterized in that cyclic oligocarbonates are added in large amounts, for example 0.5% to 4%, and are homogenized in the matrix of a linear BPA polycarbonate at 285° C. by means of a twin-shaft extruder. In the course of this, the flowability increases as the amount of cyclic oligocarbonates rises. At the same time, however, there is a distinct decrease in the glass transition temperature and hence the heat distortion resistance. This is undesirable in the industrial applications of (co)polycarbonate compositions having relatively high heat distortion resistances. This disadvantage then has to be compensated for through the use of higher amounts of costly cobisphenols.

The conventional way of improving flow is to use BDP (bisphenol A diphosphate), in amounts of up to more than 10 wt %, in order to achieve the desired effect. However, this causes a very severe reduction in heat distortion resistance.

Diglycerol esters are mentioned in connection with transparent, antistatic compositions, for example in JP2011108435 A, JP2010150457 A, JP2010150458 A.

JP2009292962 A describes specific embodiments where the ester has at least 20 carbon atoms. JP2011256359 A describes flame-retarded, UV-stabilized, antistatic compositions using diglycerol esters,

The present invention accordingly has for its object to find compositions comprising aromatic polycarbonate compositions which exhibit an improved flowability while heat distortion resistance remains virtually constant.

However, the prior art does not provide one skilled in the art with any indication of how to improve the flowability of (co)polycarbonate compositions/of PC blends for a predetermined/defined heat distortion resistance. In particular, there is no indication concerning the effect of esters of carboxylic acids with diglycerol on rheological and optical properties in a concentration range smaller than 5 wt %.

It was found that, surprisingly, compositions composed of specific (High Tg) copolycarbonates (component A; T_{g}: glass transition temperature) with a further (co)polycarbonate (component B) consistently show an improved flowability when certain amounts of an ester of carboxylic acids with diglycerol are present. The heat distortion resistance (Vicat temperature) remains practically unchanged.

The described novel property combinations are an important criterion for the mechanical and thermal performance of injection molded/extruded components. Injection moldings or extrudates produced from the copolycarbonate compositions according to the invention have significantly improved flow properties without a deterioration in thermal properties.

The present invention therefore provides copolycarbonate compositions comprising
A) 67.0 to 99.95 wt % of at least one copolycarbonate comprising monomer units selected from the group consisting of the structural units of general formulae (1a), (1b), (1c) and (1d)

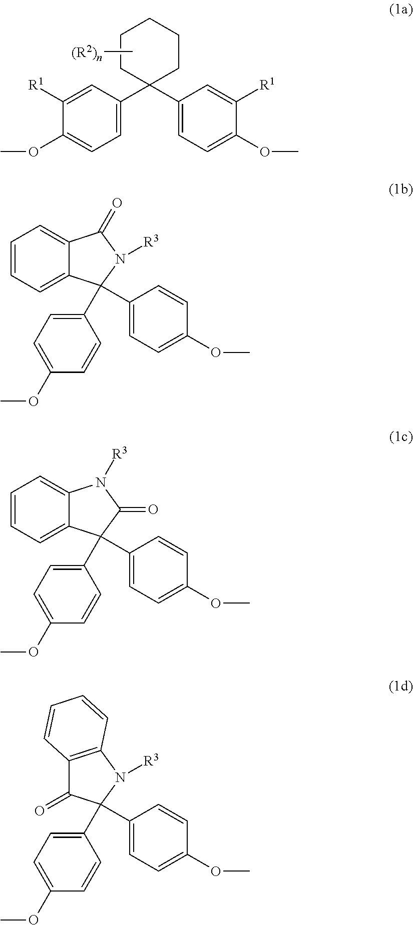

in which
   R¹ represents hydrogen or C₁-C₄-alkyl, preferably hydrogen,
   R² represents C₁-C₄-alkyl, preferably methyl,
   n represents 0, 1, 2 or 3, preferably 3, and
   R³ represents C₁-C₄-alkyl, aralkyl or aryl, preferably methyl or phenyl, very particularly preferably methyl,
or
67.0 to 99.95 wt % of a blend of the one or more copolycarbonates and at least one further homo- or copolycarbonate comprising one or more monomer units of general formula (2):

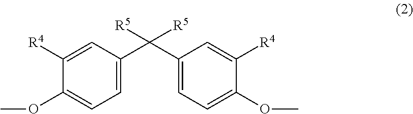

in which
   R⁴ represents H, linear or branched C₁-C₁₀ alkyl, preferably linear or branched C₁-C₆ alkyl, particularly preferably linear or branched C₁-C₄ alkyl, very particularly preferably C₁-alkyl (methyl), and
   R⁵ represents linear or branched C₁-C₁₀ alkyl, preferably linear or branched C₁-C₆ alkyl, particularly preferably linear or branched C₁-C₄ alkyl, very particularly preferably C₁-alkyl (methyl);
wherein the optionally present further homo- or copolycarbonate has no monomer units of formulae (1a), (1b), (1c) and (1d);
B) 0.05 to 3.0 wt % of at least one di glycerol ester; and
C) 0 to 30.0 wt % of one or more additives and/or fillers.

Definitions

C₁-C₄-alkyl in the context of the invention represents for example methyl, ethyl, n-propyl, iso-propyl, n-butyl, sec.-butyl, tert.-butyl, C₁-C₆-alkyl moreover represents for example n-pentyl, 1-methylbutyl, 2-methylbutyl, 3-methylbutyl, neo-pentyl, 1-ethylpropyl, cyclohexyl, cyclopentyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl or 1-ethyl-2-methylpropyl, C₁-C ₁₀-alkyl moreover represents for example n-heptyl and n-octyl, pinacyl, adamantyl, the isomeric menthyls, n-nonyl, n-decyl, C₁-C₃₄-alkyl moreover represents for example n-dodecyl, n-tridecyl, n-tetradecyl, n-hexadecyl or n-octadecyl. The same applies for the corresponding alkyl radical for example in aralkyl/alkylaryl, alkylphenyl or alkylcarbonyl radicals. Alkylene radicals in the corresponding hydroxyalkyl or aralkyl/alkylaryl radicals represent for example the alkylene radicals corresponding to the preceding alkyl radicals.

Aryl represents a carbocyclic aromatic radical having 6 to 34 skeletal carbon atoms. The same applies for the aromatic part of an arylalkyl radical, also known as an aralkyl radical, and for aryl constituents of more complex groups, for example arylcarbonyl radicals.

Examples of C₆-C₃₄-aryl are phenyl, o-, p-, m-tolyl, naphthyl, phenanthrenyl, anthracenyl and fluorenyl.

Arylalkyl and aralkyl each independently represent a straight-chain, cyclic, branched or unbranched alkyl radical as defined above which may be mono-, poly- or persubstituted by aryl radicals as defined above.

The above lists are illustrative and should not be regarded as limiting.

In the context of the present invention, ppb and ppm are understood to mean parts by weight unless stated otherwise.

In the context of the present invention—unless explicitly stated otherwise—the stated wt % values for the components A, B and C are each based on the total weight of the composition. The composition may contain further components in addition to components A, B and C. In a preferred embodiment the composition consists of the components A, B and optionally C.

Component A

The copolycarbonate composition according to the invention comprises as component A 67.0 to 99.95 wt % of a copolycarbonate comprising one or more monomer units of formulae (1a), (1b), (1c) and (1d) or of a blend of the copolycarbonate comprising one or more monomer units of formulae (1a), (1b), (1c) and (1d) and a further homo- or copolycarbonate comprising one or more monomer units of general formula (2).

It is preferable when component A is present in the composition in an amount of 70.0 to 99.0 wt %, preferably 80.0 to 99.0 wt % and particularly preferably 85.0 to 98.5 wt %, in each case based on the total weight of the composition.

In a preferred embodiment the amount of the copolycarbonate comprising one or more monomer unit(s) of general formulae (1a), (1b), (1c) and (1d) in the composition is at least 50 wt %, particularly preferably at least 60 wt %, very particularly preferably at least 75 wt %.

The monomer unit(s) of general formula (1a) is/are introduced via one or more corresponding diphenols of general formula (1a′):

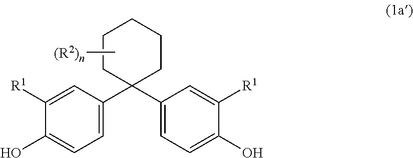

in which
R¹ represents hydrogen or C₁-C₄-alkyl, preferably hydrogen,
R² represents C₁-C₄-alkyl, preferably methyl, and
n represents 0, 1, 2 or 3, preferably 3.

The diphenols of formulae (1a′) to be employed in accordance with the invention and the employment thereof in homopolycarbonates are disclosed in DE 3918406 for example.

Particular preference is given to 1,1-bis-(4-hydroxyphenyl)-3,3,5-trimethylcyclohexane (Bisphenol TMC) having the formula (1a″):

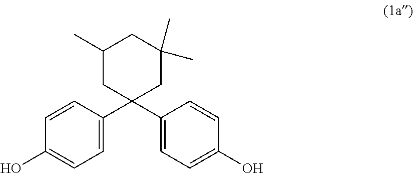 [SMILES: CC1CC(C)(C)CC(c2ccc(O)cc2)(c2ccc(O)cc2)C1]

The monomer unit(s) of general formula (1b), (1c) and (1d) are introduced via one or more corresponding diphenols of general formulae (1b′), (1c′) and (1d′):

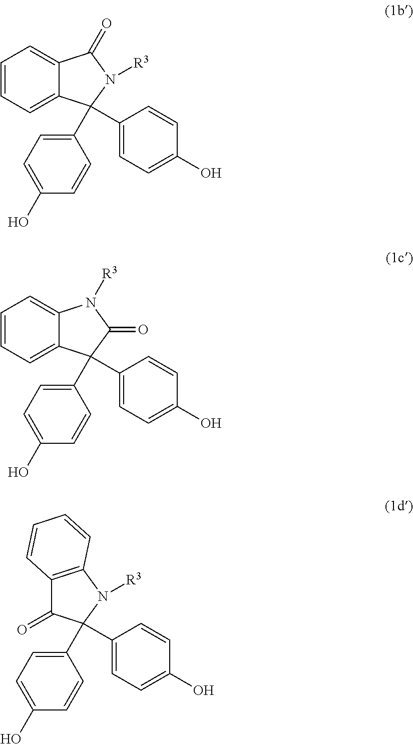

in which R³ represents C₁-C₄-alkyl, aralkyl or aryl, preferably methyl or phenyl, very particularly preferably methyl,

In addition to one or more monomer units of formulae (1a), (1b), (1c) and (1d) the copolycarbonate of component A may comprise one or more monomer unit(s) of formula (3):

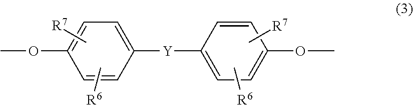

in which
R⁶ and R⁷ independently of one another represent H, C₁-C₁₈-alkyl-, C₁-C₁₈-alkoxy, halogen such as Cl or Br or respectively optionally substituted aryl or aralkyl, preferably H or C₁-C₁₂-alkyl, particularly preferably H or C₁-C₈-alkyl and very particularly preferably H or methyl, and
Y represents a single bond, —SO₂—, —CO—, —O—, —S—, C₁-C₆-alkylene or C₂-C₅-alkylidene, furthermore C₆-C₁₂-arylene, which may optionally be fused with further heteroatom-comprising aromatic rings.

The monomer unit(s) of general formula (3) is/are introduced via one or more corresponding diphenols of general formula (3a):

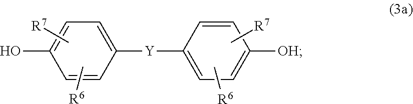

wherein R⁶, R⁷ and Y each have the meanings stated above in connection with formula (3).

Examples of the diphenols of formula (3a) which may be employed in addition to the diphenols of formula (1a′), (1b), (1c′) and (1d′) include hydroquinone, resorcinol, dihydroxybiphenyls, bis-(hydroxyphenyl)-alkanes, bis-(hydroxyphenyl)-sulfides, bis-(hydroxyphenyl) ethers, bis-(hydroxyphenyl)-ketones, bis-(hydroxyphenyl)-sulfones, bis-(hydroxyphenyl)-sulfoxides, α,α′-bis-(hydroxyphenyl)-diisopropylbenzenes and the ring-alkylated and ring-halogenated compounds thereof and also α,ω-bis-(hydroxyphenyl)-polysiloxanes.

Preferred diphenols of formula (3a) are for example 4,4′-dihydroxybiphenyl (DOD), 4,4′-dihydroxybiphenyl ether (DOD ether), 2,2-bis-(4-hydroxyphenyl)-propane (bisphenol A), 2,4-bis-(4-hydroxyphenyl)-2-methylbutane, 1,1-bis-(4-hydroxyphenyl)-1 -phenylethane, 1,1-bis[2-(4-hydroxyphenyl)-2-propyl]-benzene, 1,3-bis[2-(4-hydroxyphenyl)-2-propyl]-benzene (bisphenol M), 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfone, 2,4-bis-(3,5-dimethyl-4-hydroxyphenyl)-2-methylbutane, 2,2-bis-(3,5-dichloro-4-hydroxyphenyl)-propane and 2,2-bis-(3,5-dibromo-4-hydroxyphenyl)-propane.

Particularly preferred diphenols are for example 2,2-bis-(4-hydroxyphenyl)-propane (bisphenol A), 4,4′-dihydroxybiphenyl (DOD), 4,4′-dihydroxybiphenyl ether (DOD ether), 1,3-bis[2-(4-hydroxyphenyl)-2-propyl]-benzene (bisphenol M), 2,2-bis-(3,5-dimethyl-4-hydroxyphenyl)-propane, 1,1 -bis-(4-hydroxyphenyl)-1 -phenylethane, 2,2-bis-(3,5-dichloro-4-hydroxyphenyl)-propane and 2,2-bis-(3,5-dibromo-4-hydroxyphenyl)-propane.

Very particular preference is given to compounds of general formula (3b),

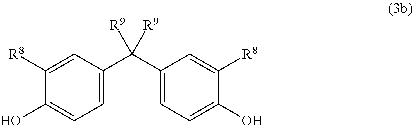

in which R⁸ represents H, linear or branched C₁-C₁₀-alkyl, preferably linear or branched C₁-C₆-alkyl, particularly preferably linear or branched C₁-C₄-alkyl, very particularly preferably H or C₁-alkyl (methyl), and
in which R⁹ represents linear or branched C₁-C₁₀-alkyl, preferably linear or branched C₁-C₆-alkyl, particularly preferably linear or branched C₁-C₄-alkyl, very particularly preferably C₁-alkyl (methyl).

Diphenol (3c) in particular is very particularly preferred here.

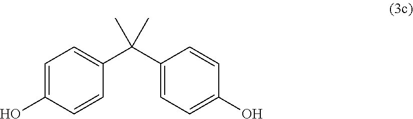 [SMILES: CC(C)(c1ccc(O)cc1)c1ccc(O)cc1]

The diphenols of general formulae (3a) may be used either alone or else in admixture with one another. The diphenols are known from the literature or producible by literature methods (see for example H. J. Buysch et al., Ullmann's Encyclopedia of Industrial Chemistry, VCH, New York 1991, 5. Ed., Vol. 19, p. 348).

The total proportion of the monomer units of formulae (1a), (1b), (1c) and (1d) in the copolycarbonate is preferably 0.1-88 mol %, particularly preferably 1 - 86 mol %, very particularly preferably 5 - 84 mol % and in particular 10 - 82 mol % (based on the sum of the moles of diphenols employed).

In a preferred embodiment of the composition according to the invention the diphenoxide units of the copolycarbonates of component A are derived from monomers having the general structures of the abovedescribed formulae (1a″) and (3a).

In another preferred embodiment of the composition according to the invention the diphenoxide units of the copolycarbonates of component A are derived from monomers having the general structures of the abovedescribed formulae (3a) and (1b), (1c′) and/or (1d′).

The copolycarbonate component of the copolycarbonate compositions may be present as block and random copolycarbonate. Random copolycarbonates are particularly preferred.

The ratio of the frequency of the diphenoxide monomer units in the copolycarbonate is calculated from the molar ratio of the diphenols employed.

The optionally present homo- or copolycarbonate of component A comprises monomer unit(s) of general formula (2). Said units are introduced via a diphenol of general formula (2a):

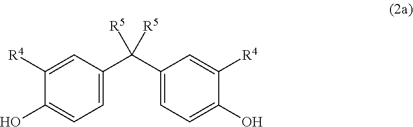

in which. R⁴ represents H, linear or branched C₁-C₁₀-alkyl, preferably linear or branched C₁-C₆-alkyl, particularly preferably linear or branched C_{I} -C₄-alkyl, very particularly preferably H or C₁-alkyl (methyl) and
in which R⁵ represents linear or branched C₁-C ₁₀-alkyl, preferably linear or branched C₁-C₆-alkyl, particularly preferably linear or branched C₁-C₄-alkyl, very particularly preferably C₁-alkyl (methyl).

Diphenol (3c) in particular is very particularly preferred here.

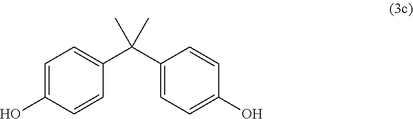 [SMILES: CC(C)(c1ccc(O)cc1)c1ccc(O)cc1]

In addition to one or more monomer units of general formulae (2) one or more monomer units of formula (3) as described above for component A may be present.

Provided that a blend is present as component A said blend preferably comprises a homopolycarbonate based on bisphenol A.

Production Process

Preferred methods of production of the homo- or coplycarbonates (also collectively referred to hereinbelow as (co) polycarbonates) preferably employed in the composition according to the invention as component A, including the (co)polyestercarbonates, are the interfacial method and the melt transesterification process.

To obtain high molecular weight (co)polycarbonates by the interfacial method the alkali salts of diphenols are reacted with phosgene in a biphasic mixture. The molecular weight may be controlled by the amount of monophenols which act as chain terminators, for example phenol, tert.-butylphenol or cumylphenol, particularly preferably phenol, tert.-butylphenol. These reactions form practically exclusively linear polymers. This may be confirmed by end-group analysis. Through deliberate use of so-called branching agents, generally polyhydroxylated compounds, branched polycarbonates are also obtained.

Employable as branching agents are small amounts, preferably amounts between 0,05 and 5 mol %, particularly preferably 0.1-3 mol %, very particularly preferably 0.1-2 mol %, based on the moles of diphenols employed, of trifunctional compounds such as, for example, isatin biscresol (IBC) or phloroglucin, 4,6-dimethyl-2,4,6-tri-(4-hydroxyphenyl)-hept-2-ene; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane (TIPP; tri-(4-hydroxyphenyl)-phenylmethane; 2,2-bis-[4,4-bis-(4-hydroxyphenyl)-cyclo-hexyl]-propane; 2,4-bis-(4-hydroxyphenyl-isopropyl)-phenol; 2,6-bis-(2-hydroxy-5′-methyl-benzyl)-4-methylphenol; 2-(4-hydroxyphenyl)-2-(2,4-dihydroxyphenyl)-propane; hexa-(4-(4-hydroxyphenyl-isopropyl)-phenyl) orthoterephthalate; tetra-(4-hydroxyphenyl)-methane; tetra-(4-(4-hydroxyphenyl-isopropyl)-phenoxy)-methane; α,α′,α″-tris-(4-hydroxyphenyl)-1,3,5-triisopropylbenzene; 2,4-dihydroxybenzoic acid; trimesic acid; cyanuric chloride; 3,3-bis-(3-methyl-4-hydroxyphenyl)-2-oxo-2,3-dihydroindole; 1,4-bis-(4′,4″-dihydroxytriphenyl)-methyl)-benzene and in particular 1,1,1-tri-(4-hydroxyphenyl)-ethane (THPE) and bis-(3-methyl-4-hydroxyphenyl)-2-oxo-2,3-dihydroindole. Preference is given to using isatin biscresol and also 1,1,1-tri-(4-hydroxyphenyl)-ethane (THPE) and bis-(3-methyl-4-hydroxyphenyl)-2-oxo-2,3-dihydroindole as branching agents.

The use of these branching agents results in branched structures. The resulting long-chain branching normally leads to rheological properties of the obtained polycarbonates which manifests in a structural viscosity compared to linear types.

The amount of chain terminator to be employed is preferably 0.5 mol % to 10 mol %, preferably 1 mol % to 8 mol %, particularly preferably 2 mol % to 6 mol %, based on the moles of diphenols employed in each case. The addition of the chain terminators may be effected before, during or after the phosgenation, preferably as a solution in a solvent mixture of methylene chloride and chlorobenzene (8-15 wt %).

To obtain high molecular weight (co)polycarbonates by the melt transesterification process diphenols are reacted in the melt with carbonic diesters, normally diphenyl carbonate, in the presence of catalysts, such as alkali metal salts, ammonium or phosphonium compounds.

The melt transesterification process is described f©r example in Encyclopedia of Polymer Science, Vol. 10 (1969), Chemistry and Physics of Polycarbonates, Polymer Reviews, H. Schnell, Vol. 9, John Wiley and Sons, Inc. (1964) and in DE-C 10 31 512.

In the melt transesterification process diphenols of formulae (2a) and optionally (1a) are transesterified in the melt with carbonic diesters using suitable catalysts and optionally further added substances.

Carbonic diesters for the purposes of the invention are those of formulae (4) and (5)

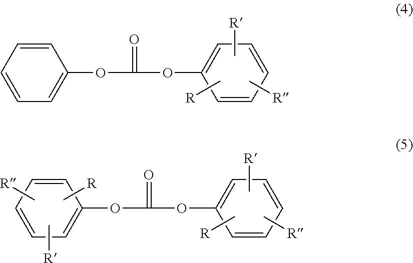

wherein
R, R′ and R″ may independently of one another represent H, optionally branched C₁-C₃₄-alkyl/cycloalkyl, C₇-C₃₄-alkaryl or C₆-C₃₄-aryl,

for example

diphenyl carbonate, butylphenyl phenyl carbonate, di(butylphenyl) carbonate, isobutylphenyl phenyl carbonate, di(isobutylphenyl) carbonate, tert-butylphenyl phenyl carbonate, di(tert-butylphenyl) carbonate, n-pentylphenyl phenyl carbonate, di(n-pentylphenyl) carbonate, n-hexylphenyl phenyl carbonate, di(n-hexylphenyl) carbonate, cyclohexylphenyl phenyl carbonate, di(cyclohexylphenyl) carbonate, phenylphenol phenyl carbonate, di(phenylphenol) carbonate, isooctylphenyl phenyl carbonate, di(isooctylphenyl) carbonate, n-nonylphenyl phenyl carbonate, di(n-nonylphenyl) carbonate, cumylphenyl phenyl carbonate, di(cumylphenyl) carbonate, naphthylphenyl phenyl carbonate, di(naphthylphenyl) carbonate, di-tert-butylphenyl phenyl carbonate, di(di-tert-butylphenyl) carbonate, dicurnylphenyl phenyl carbonate, di(dicurnylphenyl) carbonate, 4-phenoxyphenyl phenyl carbonate, di(4-phenoxyphenyl) carbonate, 3-pentadecylphenyl phenyl carbonate, di-(3-pentadecylphenyl) carbonate, tritylphenyl phenyl carbonate, di(tritylphenyl) carbonate,

preferably diphenyl carbonate, tert-butylphenyl phenyl carbonate, di-(tert-butylphenyl) carbonate, phenylphenol phenyl carbonate, di(phenylphenol) carbonate, cumylphenyl phenyl carbonate, di(cumylphenyl) carbonate, particularly preferably diphenyl carbonate.

Mixtures of the recited carbonic diesters may also be employed.

The proportion of carbonic esters is 100 to 130 mol %, preferably 103 to 120 mol %, particularly preferably 103 to 109 mol %, based on the one or more diphenols.

As described in the recited literature basic catalysts such as alkali metal and alkaline earth metal hydroxides and oxides but also ammonium or phosphonium salts referred to hereinbelow as onium salts are employed as catalysts in the melt transesterification process. Preference is given to employing onium salts, particularly preferably phosphonium salts. For the purposes of the invention phosphonium salts are those having the following general formula (6)

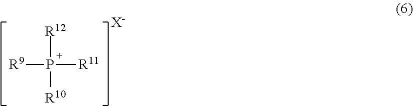

wherein
R⁹⁻¹² may be identical or different C₁-C₁₀-alkyls, C₆-C₁₀-aryls, C₇-C₁₀-aralkyls or C₅-C₆-cycloalkyls, preferably methyl or C₆-C₁₄-aryls, particularly preferably methyl or phenyl, and
X⁻ may be an anion such as hydroxide, sulfate, hydrogensulfate, hydrogencarbonate, carbonate, a halide, preferably chloride, or an alkoxide of formula OR¹⁷, wherein R¹⁷ may be C₆-C₁₄-aryl or C₇-C₁₂-aralkyl, preferably phenyl.

Preferred catalysts are tetraphenylphosphonium chloride, tetraphenylphosphonium hydroxide, tetraphenylphosphonium phenoxide, particularly preferably tetraphenylphosphonium phenoxide.

The catalysts are preferably employed in amounts of 10⁻⁸ to 10⁻³ mol, based on one mole of diphenol, particularly preferably in amounts of 10⁻⁷ to 10⁻⁴ mol.

Further catalysts may be employed alone or optionally in addition to the onium salt to increase the rate of the polymerization. These include salts of alkali metals and alkaline earth metals, such as hydroxides, alkoxides and aryloxides of lithium, sodium and potassium, preferably hydroxide, alkoxide or aryloxide salts of sodium. Greatest preference is given to sodium hydroxide and sodium phenoxide. The amounts of the cocatalyst may be in the range from 1 to 200 ppb, preferably 5 to 150 ppb and most preferably 10 to 125 ppb in each case reckoned as sodium.

The addition of the catalysts is effected in solution in order to avoid deleterious overconcentrations during metering. The solvents are system- and process-inherent compounds, for example diphenol, carbonic diesters or monohydroxyaryl compounds. Particular preference is given to monohydroxyaryl compounds because it is familiar to one skilled in the art that the diphenols and carbonic dieesters readily undergo transformation and decomposition even at only mildly elevated temperatures, in particular under the action of catalysts. This negatively affects polycarbonate qualities. In the industrially most important transesterification process for producing polycarbonate the preferred compound is phenol. Phenol is also a compelling option because during production the preferably employed tetraphenylphosphonium phenoxide catalyst is isolated as a cocrystal with phenol.

The process for producing the (co) polycarbonates present in the composition according to the invention by the transesterification process may be discontinuous or else continuous. Once the diphenols of formulae (2a) and optionally (1a) and carbonic diesters are present as a melt, optionally with further compounds, the reaction is initiated in the presence of the catalyst. The conversion/the molecular weight is increased with rising temperatures and falling pressures in suitable apparatuses and devices by removing the eliminated monohydroxyaryl compound until the desired final state is achieved. Choice of the ratio of diphenol to carbonic diester and of the rate of loss of the carbonic diester via the vapors and of any added compounds, for example of a higher-boiling monohydroxyaryl compound, said rate of loss arising through choice of procedure/plant for producing the polycarbonate, is what decides the end groups in terms of their nature and concentration.

With regard to the manner in which, the plant in which and the procedure by which the process is executed, there is no limitation or restriction.

Moreover, there is no specific limitation and restriction with regard to the temperatures, the pressures and catalysts used, in order to perform the melt transesterification reaction between the diphenol and the carbonic diester, and any other reactants added. Any conditions are possible, provided that the temperatures, pressures and catalysts chosen enable a melt transesterification with correspondingly rapid removal of the eliminated monohydroxyaryl compound.

The temperatures over the entire process are generally 180 to 330° C. at pressures of 15 bar absolute to 0.01 mbar absolute.

It is normally a continuous procedure that is chosen, because this is advantageous for product quality.

Preferably, the continuous process for producing polycarbonates is characterized in that one or more diphenols with the carbonic diester, also any other reactants added, using the catalysts, after pre-condensation, without removing the monohydroxyaryl compound formed, in several reaction evaporator stages which then follow at temperatures rising stepwise and pressures falling stepwise, the molecular weight is built up to the desired level.

The devices, apparatuses and reactors that are suitable for the individual reaction evaporator stages are, in accordance with the process sequence, heat exchangers, flash apparatuses, separators, columns, evaporators, stirred vessels and reactors or other purchasable apparatuses which provide the necessary residence time at selected temperatures and pressures. The devices chosen must enable the necessary input of heat and be constructed such that they are able to cope with the continuously increasing melt viscosities.

All devices are connected to one another by pumps, pipelines and valves. The pipelines between all the devices should of course be as short as possible and the curvature of the conduits should be kept as low as possible in order to avoid unnecessarily prolonged residence times. At the same time, the external, i.e. technical, boundary conditions and requirements for assemblies of chemical plants should be observed.

To perform the process by a preferred continuous procedure the coreactants can either be melted together or else the solid diphenol can be dissolved in the carbonic diester melt or the solid carbonic diester can be dissolved in the melt of the diphenol or both raw materials are combined in molten form, preferably directly from production. The residence times of the separate melts of the raw materials, in particular the residence time of the melt of the diphenol, are adjusted so as to be as short as possible. The melt mixture, by contrast, because of the depressed melting point of the raw material mixture compared to the individual raw materials, can reside for longer periods at correspondingly lower temperatures without loss of quality.

Thereafter, the catalyst, preferably dissolved in phenol, is mixed in and the melt is heated to the reaction temperature. At the start of the industrially important process for producing polycarbonate from 2,2-bis(4-hydroxyphenyl)propane and diphenyl carbonate, this temperature is 180 to 220° C., preferably 190 to 210° C., very particularly preferably 1.90° C. Over the course of residence times of 15 to 90 min, preferably 30 to 60 min, the reaction equilibrium is established without withdrawing the hydroxyaryl compound formed. The reaction can be run at atmospheric pressure, but for industrial reasons also at elevated pressure. The preferred pressure in industrial plants is 2 to 15 bar absolute.

The melt mixture is expanded into a first vacuum chamber, the pressure of which is set to 100 to 400 mbar, preferably to 150 to 300 mbar, and then heated directly back to the inlet temperature at the same pressure in a suitable device. In the expansion operation, the hydroxyaryl compound formed is evaporated together with monomers still present. After a residence time of 5 to 30 min in a bottoms reservoir, optionally with pumped circulation, at the same pressure and the same temperature, the reaction mixture is expanded into a second vacuum chamber, the pressure of which is 50 to 200 mbar, preferably 80 to 150 mbar, and directly afterwards heated in a suitable apparatus at the same pressure to a temperature of 190° C. to 250° C., preferably 210° C. to 240° C., particularly preferably 210° C. to 230° C. Here too, the hydroxyaryl compound formed is evaporated together with monomers still present. After a residence time of 5 to 30 min in a bottoms reservoir, optionally with pumped circulation, at the same pressure and the same temperature, the reaction mixture is expanded into a third vacuum chamber, the pressure of which is 30 to 150 mbar, preferably 50 to 120 mbar, and directly afterwards heated in a suitable apparatus at the same pressure to a temperature of 220° C. to 280° C., preferably 240° C. to 270° C., particularly preferably 240° C. to 260° C. Here too, the hydroxyaryl compound formed is evaporated together with monomers still present. After a residence time of 5 to 20 min in a bottoms reservoir, optionally with pumped circulation, at the same pressure and the same temperature, the reaction mixture is expanded into a further vacuum chamber, the pressure of which is 5 to 100 mbar, preferably 15 to 100 mbar, particularly preferably 20 to 80 mbar, and directly afterwards heated in a suitable apparatus at the same pressure to a temperature of 250° C. to 300° C., preferably 260° C. to 290° C., particularly preferably 260 to 280° C. Here too, the hydroxyaryl compound formed is evaporated together with monomers still present.

The number of these stages, 4 here by way of example, may vary between 2 and 6. The temperatures and pressures should be adjusted appropriately when the number of stages is altered in order to obtain comparable results. The relative viscosity of the oligomeric carbonate attained in these stages is between 1.04 and 1.20, preferably between 1.05 and 1.15, particularly preferably between 1.06 to 1.10.

The oligocarbonate thus obtained, after a residence time of 5 to 20 min in a bottoms reservoir, optionally with pumped circulation, at the same pressure and the same temperature as in the last flash/evaporator stage, is conveyed into a disk or cage reactor and subjected to further condensation at 250° C. to 310° C., preferably 250° C. to 290° C., particularly preferably 250° C. to 280° C., at pressures of 1 to 15 mbar, preferably 2 to 10 mbar, with residence times of 30 to 90 min, preferably 30 to 60 min. The product attains a relative viscosity of 1.12 to 1.28, preferably 1.13 to 1.26, particularly preferably 1.13 to 1.24.

The melt leaving this reactor is brought to the desired final viscosity/the final molecular weight in a further disk or cage reactor. The temperatures are 270° C. to 330° C., preferably 280° C. to 320° C., particularly preferably 280° C. to 310° C., and the pressure is 0.01 to 3 mbar, preferably 0.2 to 2 mbar, with residence times of 60 to 180 min, preferably 75 to 150 min. The relative viscosities are set to the level necessary for the application envisaged and are 1.18 to 1.40, preferably 1.18 to 1.36, particularly preferably 1.18 to 1.34.

The function of the two cage reactors or disk reactors can also be combined in one cage reactor or disk reactor.

The vapors from all the process stages are directly led off, collected and processed. This processing is generally effected by distillation in order to achieve high purities of the substances recovered. This can be effected, for example, according to German patent application no. 10 100 404. Recovery and isolation of the eliminated monohydroxyaryl compound in ultrapure form is an obvious aim from an economic and environmental point of view. The monohydroxyaryl compound can be used directly for producing a diphenol or a carbonic diester.

It is a feature of the disk or cage reactors that they provide a very large, constantly renewing surface under reduced pressure with high residence times. The disk or cage reactors have a geometric shape in accordance with the melt viscosities of the products. Suitable examples are reactors as described in DE 44 47 422 C2 and EP A 1 253 163 or twin shaft reactors as described in WO A 99/28 370.

The oligocarbonates, including those of very low molecular weight, and the finished polycarbonates are generally conveyed by means of gear pumps, screws of a wide variety of designs or positive displacement pumps of a specific design.

Analogously to the interfacial method, it is possible to use polyfunctional compounds as branching agents.

The relative solution viscosity of the poly- or copolycarbonates present in the composition of the invention, determined according to DIN 51562, is preferably in the range of 1.15-1.35,

The weight-average molecular weights of homo- or copolycarbonates present in the composition according to the invention are preferably 15 000 to 40 000 g/mol, particularly preferably 17 000 to 36 000 g/mol, and very particularly preferably 17 000 to 34 000 g/mol, and are determined by GPC against a polycarbonate calibration.

Particular preference is given to copolycarbonate compositions in which the copolycarbonate of component A and/or the optionally also present further homo- or copolycarbonate of component A at least partly comprise as an end group a structural unit derived from phenol and/or a structural unit derived from 4-tert-butylphenol.

The compositions according to the invention comprise as component B at least one diglycerol ester. Esters based on various carboxylic acids are suitable. The esters may also be based on different isomers of diglycerol. It is possible to use not only monoesters but also polyesters of diglycerol. It is also possible to use mixtures instead of pure compounds.

Isomers of diglycerol which form the basis of the diglycerol esters employed in accordance with the invention are the following:

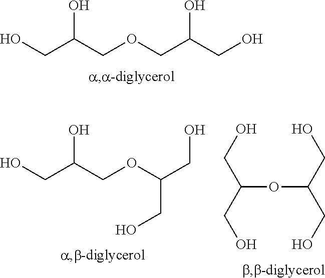

Mono- or polyesterified isomers of these formulae can be employed as the diglycerol esters used in accordance with the invention. Employable mixtures are composed of the diglycerol reactants and the ester end products derived therefrom, for example having molecular weights of 348 g/mol (monolauryl ester) or 530 g/mol (dilauryl ester).

The diglycerol esters present according to the invention in the composition are preferably derived from saturated or unsaturated monocarboxylic acids having a chain length from 6 to 30 carbon atoms. Suitable monocarboxylic acids are for example caprylic acid (C₇H₁₅COOH, octanoic acid), capric acid (C₉H₁₉COOH, decanoic acid), lauric acid (C₁₁H₂₃COOH, dodecanoic acid), myristic acid (C₁₃H₂₇COOH, tetradecanoic acid), palmitic acid (C₁₅H₃₁COOH, hexadecanoic acid), margaric acid (C₁₆H₃₃COOH, heptadecanoic acid), stearic acid (C₁₇H₃₅COOH, octadecanoic acid), arachidic acid (C₁₁H₃₉COOH, cicosanoic acid), behenic acid (C₂₁H₄₃COOH, docosanoic acid), lignoceric acid (C₂₃H₄₇COOH, tetracosanoic acid), palmitoleic acid (C₁₅H₂₉COOH, (9Z)-hexadeca-9-enoic acid), petroselic acid (C₁₇H₃₃COOH, (6Z)-octadeca-6-enoic acid), (9Z)-octadeca-9-enoic acid), elaidic acid (C₁₇H₃₃COOH, (9E)-octadeca-9-enoic acid), linoleic acid (C₁₇H₃₁COOH, (9Z,12Z)-octadeca-9,12-dienoic acid), alpha- and gamma-linolenic acid (C₁₇H₂₉COOH, (9Z,12Z,15Z)-octadeca-9,12,15-trienoic acid and (6Z,9Z,12Z)-octadeca-6,9,12-trienoic acid), arachidonic acid (C₁₉H₃₁COOH, (5Z,8Z,11Z,14Z)-eicosa-5,8,11,14-tetraenoic acid), timnodonic acid (C₁₉H₂₉COOH, (5Z,8Z,11Z,14Z,17Z)-eicosa-5,8,11,14,17-pentaenoic acid) and cervonic acid. (C₂₁H₃₁COOH, (4Z,7Z,10Z,13Z,16Z,19Z)-docosa-4,7,10,13,16,19-hexaenoic acid). Particular preference is given to lauric acid, palmitic acid and stearic acid.

In a preferred embodiment the diglycerol ester present in the composition is at least one ester of formula (I)

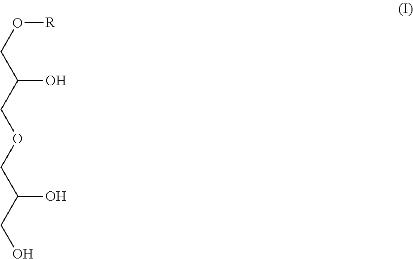

where R═COCₙH₂ₙ₊₁ and/or R═COR′,
wherein R′ is a branched alkyl radical or a branched or unbranched alkenyl radical and CₙH₂ₙ₊₁ is an aliphatic, saturated linear alkyl radical.

n is preferably an integer from 6-24 and examples of CₙH₂ₙ₊₁ are therefore n-hexyl, n-heptyl, n-octyl, n-nonyl, n-decyl, n-dodecyl, n-tridecyl, n-tetradecyl, n-hexadecyl or n-octadecyl. More preferably n =8 to 18, particularly preferably 10 to 16, very particularly preferably 12 (diglycerol monolaurate isomer having a molecular weight of 348 g/mol, which is particularly preferred as the main product in a mixture). It is preferable in accordance with the invention when the abovementioned ester moieties are present also in the case of the other isomers of diglycerol.

A mixture of various diglycerol esters may therefore also be concerned.

Preferably employed diglycerol esters have an HLB value of at least 6, particularly preferably 6 to 12, the HLB value being defined as the “hydrophilic-lipophilic balance”, calculated as follows according to the Griffin method:

HLB=20×(1−M_{lipophilic}/M),

wherein M_{lipophilic} is the molar mass of the lipophilic proportion of the diglycerol ester and M is the molar mass of the &glycerol ester.

The amount of diglycerol ester is 0.05 to 3.0 wt %, preferably 0,10 to 2.0 wt %, particularly preferably 0.15 to 1.50 wt % and very particularly preferably 0.20 to 1.0 wt %.

Component C

The present invention further provides compositions comprising components A and B and optionally as component C at least one added substance preferably selected from the group of the added substances customary for these thermoplastics, such as fillers, carbon black, UV stabilizers, IR absorbers, thermal stabilizers, antistats and pigments, colorants in the customary amounts; it is optionally possible to improve demolding characteristics, flow characteristics and/or flame retardancy by adding external demolding agents, flow agents and/or flame retardants such as sulfonate salts, PTFE polymers/PTFE copolymers, brominated oligocarbonates, or oligophosphates and phosphazenes (e.g. alkyl and aryl phosphites, phosphates, phosphanes, low molecular weight carboxylic esters, halogen compounds, salts, chalk, talc, thermally or electrically conductive carbon blacks or graphites, quartz/quartz flour, glass and carbon fibers, pigments or else additives for reduction of the coefficient of linear thermal expansion (CLTE) and combination thereof. Such compounds are described for example in WO 99/55772, p. 15-25, and in “Plastics Additives”, R. Gächter and H. Müller, Hanser Publishers 1983).

If inorganic added substances, for example one or more fillers, are present in the composition, the total amount of organic and inorganic added substances may be up to 30 wt % (based on the overall composition).

The composition generally comprises 0 to 5.0 wt %, preferably 0 to 2.50 wt %, particularly preferably 0 to 1.60 wt %, very particularly preferably 0.03 to 1.50 wt %, especially particularly preferably 0.02 to 1.0 wt % (based on the overall composition), of organic added substances.

The demolding agents optionally added to the compositions according to the invention are preferably selected from the group consisting of pentaerythritol tetrastearate, glycerol monostearate and long-chain fatty acid esters, for example stearyl stearate and propanediol stearate, and mixtures thereof. The demolding agents are preferably used in amounts of 0.05 vit % to 2.00 wt %, preferably in amounts of 0.1 wt % to 1.0 wt %, particularly preferably in amounts of 0.15 wt % to 0.60 wt % and very particularly preferably in amounts of 0.20 wt % to 0.50 wt % based on the total weight of components A, B and C.

Suitable added substances are described for example in “Additives for Plastics Handbook, John Murphy, Elsevier, Oxford 1999”, in “Plastics Additives Handbook, Hans Zweifel, Hanser, Munich 2001”.

Suitable antioxidants/thermal stabilizers are for example:

alkylated monophenols, alkylthiomethylphenols, hydroquinones and alkylated hydroquinones, tocopherols, hydroxylated thiodiphenyl ethers, alkylidenebisphenols, O—, N— and S-benzyl compounds, hydroxybenzylated malonates, aromatic hydroxybenzyl compounds, triazine compounds, acylaminophenols, esters of β-(3,5-di-tert-butyl-4-hydroxyphenyl)propionic acid, esters of β-(5-tert-butyl-4-hydroxy-3-methylphenyl)propionic acid, esters of β-(3,5-dicyclohexyl-4-hydroxy-phenyl)propionic acid, esters of 3,5-di-tert-butyl-4-hydroxyphenylacetic acid, amides of β-(3,5-di-tert-butyl-4-hydroxyphenyl)propionic acid, suitable thio synergists, secondary antioxidants, phosphites and phosphonites, benzofuranones and indolinones.

Preferentially suitable thermal stabilizers are tris(2,4-di-tert-butylphenyl) phosphite (Irgafos 168), tetrakis(2,4-di-tert-butylphenyl)-[1,1-biphenyl]-4,4′-diyl bisphosphonite, triisoctyl phosphate (TOF), octadecyl-3-(3,5-di-tert-butyl-4-hydroxyphenyl) propionate (Irganox 1076), bis(2,4-dicu1nylphenyl)pentaerythritol diphosphite (Doverphos S-9228), bis(2,6-di-tert-butyl-4-methylphenyl)-pentaerythritol diphosphite (ADK STAB PEP-36) and triphenylphosphine (TPP). Said thermal stabilizers are used alone or in admixture (e.g. Irganox B900 or Doverphos S-9228 with Irganox B900/Irganox 1076 or triphenylphosphine (TPP) with triisoctyl phosphate (TOF)). Thermal stabilizers are preferably used in amounts of 0.005 wt % to 2.00 wt %, preferably in amounts of 0.01 wt % to 1.0 wt %, particularly preferably in amounts of 0.015 wt % to 0.60 wt % and very particularly preferably in amounts of 0.02 wt % to 0.50 wt % based on the total weight of components A, B and C.

Suitable complexing agents for heavy metals and neutralization of traces of alkalis are o/m-phosphoric acids, fully or partly esterified phosphates or phosphites.

Suitable light stabilizers (UV absorbers) are 2-(T-hydroxyphenyl)benzotriazoles, 2-hydroxybenzophenones, esters of substituted and unsubstituted benzoic acids, acrylates, sterically hindered amines, oxamides and 2-(hydroxyphenyl)-1,3,5-triazines/substituted hydroxyalkoxyphenyl, 1,3,5-triazoles, preference being given to substituted benzotriazoles, for example 2-(2′-hydroxy-5′-methyl-phenyl)benzotriazole, 2-(2′-hydroxy-3′,5′-di-t-butylphenyl)benzotriazole, 2-(2′-hydroxy-3′-tert.-butyl-5′-methylphenyl)-5-chlorobenzotriazole, 2-(2′-hydroxy-3′,5′-tert.-butylphenyl)-5-chloro-benzotriazole, 2-(2′-hydroxy-5′-tert.-octylphenyl)-benzotriazole, 2-(2′-hydroxy-3′,5′-di-tert.-amylphenyl)benzotriazole, 2-[2′-hydroxy-3′-(3″,4″,5″,6″-tetrahydrophthalimidoethyl)-5′-methylphenyl]-benzotriazole and 2,2′-methylenebis[4-(1,1,3,3-tetramethyl butyl)-6-(2H-benzotriazol-2-yl)phenol].

Further suitable UV stabilizers are selected from the group comprising benzotriazoles (e.g. Tinuvins from BASF), triazine Tinuvin 1600 from BASF), benzophenones (Uvinuls from BASF), cyanoacrylates (Uvinuls from BASF), cinnamic esters and oxalanilides, and mixtures of these UV stabilizers.

The UV stabilizers are used in amounts of 0.01 wt % to 2.0 wt % based on the molding material, preferably in amounts of 0.05 wt % to 1.00 wt %, particularly preferably in amounts of 0.08 wt % to 0.5 wt % and very particularly preferably in amounts of 0.1 wt % to 0.4 wt % based on the overall composition.

Polypropylene glycols, alone or in combination with, for example, sulfones or sulfonamides as stabilizers, can be used to counteract damage by gamma rays.

These and other stabilizers can be used individually or in combination and can be added to the polymer in the forms mentioned.

Suitable flame-retardant additives are phosphate esters, i.e. triphenyl phosphate, resorcinol diphosphate, brominated compounds, such as brominated phosphoric esters, brominated oligocarbonates and polycarbonates, and preferably salts of fluorinated organic sulfonic acids.

Suitable impact modifiers are butadiene rubber with grafted-on styrene-acrylonitrile or methyl methacrylate, ethylene-propylene rubbers with grafted-on maleic anhydride, ethyl and butyl acrylate rubbers with grafted-on methyl methacrylate or styrene-acrylonitrile, interpenetrating siloxane and acrylate networks with grafted-on methyl methacrylate or styrene-acrylonitrile.

In addition, it is possible to add colorants such as organic dyes or pigments or inorganic pigments, carbon black, IR absorbers, individually, in a mixture or else in combination with stabilizers, glass fibers, (hollow) glass beads, inorganic fillers, for example titanium dioxide, talc, silicates or barium sulfate.

In a particularly preferred embodiment the composition according to the invention comprises at least one added substance selected from the group consisting of thermal stabilizers, demolding agents and UV absorbers, preferably in a total amount of 0.2 wt % to 2.0 wt % based on the total amount of components A, B and C. Particular preference is given to thermal stabilizers.

In a preferred embodiment the composition according to the invention comprises at least one inorganic filler as an added substance.

In a further preferred embodiment the composition according to the invention comprises 0.002 to 0.2 wt % of thermal stabilizer, 0.01 wt % to 1.00 wt % of UV stabilizer and 0.05 wt % to 2.00 wt % of demolding agent.

The copolycarbonate compositions according to the invention are produced in customary machines, for example inultishaft extruders, by compounding optionally with addition of additives and other added materials at temperatures between 280° C. and 360° C.

The copolycarbonate compositions according to the invention can be processed in a customary manner in standard machines, for example in extruders or injection molding machines, to give any shaped articles/moldings, to give films or sheets or bottles.

The copolycarbonate compositions according to the invention, optionally in a blend with other thermoplastics and/or customary additives, can be used to give any desired shaped articles/extrudates, wherever already known polycarbonates, polyestercarbonates and polyesters are used:
1. Safety glazing which, as is well known, is required in many regions of buildings, vehicles and aircraft, and as shields of helmets.
2. Production of films and film laminates.

3. Automobile headlamps, bezels, indicators, reflectors.
4. As translucent plastics having a content of glass fibers for lighting purposes. As translucent plastics having a content of barium sulfate, titanium dioxide and/or zirconium oxide or high-reflectance opaque compositions and components produced therefrom.
5. For production of precision injection moldings, for example lenses, collimators, lens holders, light guide elements and LED applications.
6. As electrical insulators for electrical conductors and for plug housings and plug connectors.
7. Housings for electrical appliances.
8. Protective glasses, eyepieces.
9. For medical applications, medical devices, for example oxygenators, dialyzers (hollow fiber dialyzers), 3-way taps, hose connectors, blood filters, injection systems, inhalers, ampoules.
10. Extruded shaped articles such as sheets and films.
11. LED applications (sockets, reflectors, heat sinks).
12. As a feedstock for compounds or as a blend partner or component in blend compositions and components produced therefrom.

This application likewise provides the compounds, blends, shaped articles, extrudates, films and film laminates made from the copolycarbonate compositions according to the invention, and likewise moldings, extrudates and films comprising coextrusion layers made from the copolycarbonate compositions according o the invention.

It is a particular feature of the compositions according to the invention that they exhibit exceptional mechanical, rheological and optical properties on account of their content of diglycerol ester.

The present invention accordingly also provides for the use of one or more of the diglycerol esters described hereinabove for improving the breaking elongation and/or reducing the yellowness index of compositions comprising a copolycarbonate or a blend of the copolycarbonate and a further homo- or copolycarbonate (component A) and optionally one or more added substances (component C).

The embodiments described hereinabove for the composition according to the invention also apply - where applicable - to the use according to the invention.

The examples which follow are intended to illustrate the invention without, however, limiting said invention.

### EXAMPLES

Raw materials used:
Component A is a blend of PC1 and PC2 (examples 1-3), copolycarbonate PC3 or PC4 (examples 4 to 9) or one of copolycarbonates PCS to PC11 (see table 7, examples 10-30).
PC 1 is a commercially available copolycarbonate based on bisphenol A and bisphenol TMC having an MVR of 18 cm³/10 min (330° C./2.16 kg) and a softening temperature (VST/B 120) of 183° C. (Apec 1895 from Bayer MaterialScience AG).
PC 2 is a polycarbonate powder based on bisphenol A having an MVR of 6 cm³/10 min (300° C./1.2 kg).). It is used to improve incorporation (metering) of component B.
PC 3 Lexan XHT2141; high heat copolycarbonate based on bisphenol A and the bisphenol of formula (Ib′) where R³=phenyl from Sabic Innovative Plastics having an MVR of 43 cm³/10 min (330° C., 2.16 kg)
PC 4 Lexan XHT4143; UV stabilized high heat copolycarbonate based on bisphenol A and the bisphenol of formula (Ib′) where R³=phenyl from Sabic Innovative Plastics
component B Poem. DL-100 (diglycerol monol.aurate, HLB=9) from Riken Vitamin.
component C triisooctyl phosphate (TOF) from Lanxess AG.

Syntheis of the Bisphenol of Formula (1b′) where R³=methyl:

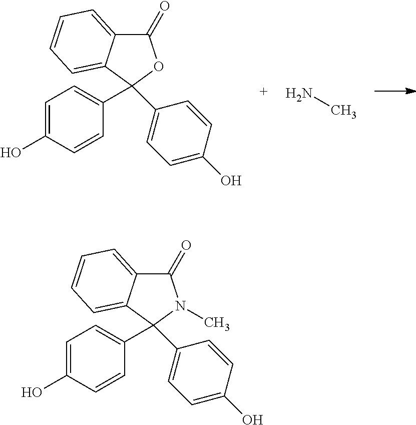

A flange reactor is initially charged with a solution of 2 kg (20.2 mol) of N-methylpyrrolidone (NMP) and 1273.3 g (4 mol) of phenolphtalein. 2 liters of water and then 18 mol of a 40% aqueous methylamine solution are added with stirring. The reaction solution turns violet upon addition of the methylamine. The mixture is then stirred for a further 8 hours at 82° C. utilizing a. dry ice cooler. This causes the coloring of the reaction batch to change to dark yellowish. Once the reaction has ended the reaction batch is precipitated by means of a dropping funnel with stirring into a reservoir of water acidified with hydrochloric acid,

The precipitated white reaction product is slurried with 2 liters of water and then suctioned off using a G3 frit. The crude product obtained is redissolved in 3.5 liters of a dilute sodium hydroxide solution (16 mol) and in turn precipitated in a reservoir of water acidified with hydrochloric acid. The reprecipitated crude product is repeatedly slurried with 2 liters of water and then suctioned off each time. This washing procedure is repeated until the conductivity of the washing water is less than 15 μS.

The thus obtained product is dried to constant mass in a vacuum drying cabinet at 90° C.

After 4-fold performance of the experiment the following yields were obtained in each case:

1a) 950 g of a white solid

1b) 890 g of a white solid.

1c) 1120 g of a white solid

1d) 1050 g of a white solid

(melting point 264° C.)

Characterization of the obtained bisphenols was effected by ¹H-NMR spectroscopy.

Synthesis of Copolycarbonate Based on a Bisphenol of Formula (1b′) where R³=methyl and Bisphenol A:

To a nitrogen-inertized solution of 532.01 g (1.6055 mol) of bisphenol. A (BPA), 2601.36 g (11.39 mol) of bisphenol from example 1, 93.74 g (0.624 mol, 4.8 mol % based on diphenols) of p-tert.-butylphenol (BUP) as chain terminator and 1196 g (29.9 mol) of sodium hydroxide in 25.9 liters of water are added 11.79 liters of methylene chloride and 14.1 liters of chlorobenzene. At a pH of 12.5 13.5 and 20° C., 2.057 kg (20.8 mol) of phosgene are introduced. In order to prevent the pH from falling below 12.5, 30% sodium hydroxide solution was added during the phosgenation. Once phosgenation is complete and after purging with nitrogen the mixture is stirred for a further 30 minutes, 14.7 g (0.13 mol, 1 mol % based on diphenols) of N-ethylpiperidine are then added as catalyst and the mixture is stirred for a further 1 hour. After removal of the aqueous phase and acidification with phosphoric acid the organic phase is washed several times with water using a separator until salt-free. The organic phase is separated off and subjected to a solvent exchange in which methylene chloride is replaced with chlorobenzene. The concentrated copolycarbonate solution in chlorobenzene is then freed of solvent using a vented extruder. The obtained polycarbonate melt extrudates are cooled in a water bath, drawn off and finally pelletized. Transparent polycarbonate pellets are obtained.

Synthesis of Copolycarbonates PC5 to PC11

Copolycarbonates PC5 to PC11 were produced as per the preceding procedure for producing copolycarbonate based on a bisphenol of formula (1b′) where R³=methyl and bisphenol A (see table 7 for stoichiometry).

Synthesis of the Copolycarbonate Compositions of Examples 1-3

The copolycarbonate compositions of examples 1-3 based on raw materials PC1 and PC2 and also component B and component C are mixed according to the formulations reported in table 1 in a twin-screw extruder at 300° C. The thus-obtained polymer compositions are pelletized and are ready for polymer physical characterizations.

Synthesis of the Copolycarbonate Compositions of Examples 4-30

The polycarbonate compositions of examples 4 to 30 are produced in a DSM Miniextruder based on the raw materials stated. The melt temperature was 330° C. The thus-obtained polymer compositions are pelletized and are ready for polymer physical characterizations.

Characterization of the Molding Materials According to the Invention (Test Methods):

Characterization of the molding materials according to the invention (test methods): Melt volume flow rate (MVR) was determined in accordance with ISO 1133 (at a test temperature of 330° C., mass 2.16 kg) using a Zwick 4106 instrument from Roell.

Vicat softening temperature VST/B120 was determined as a measure of heat distortion resistance in accordance with ISO 306 on test specimens measuring 80 mm×10 mm×4 mm with a 50 N ram loading and a heating rate of 50° C./h or of 120° C./h with a Coesfeld Eco 2920 instrument from Coesfeld Materialtest.

The yellowness index (Y.I.) was determined as per ASTM E 313 (observer: 10°/light type: D65) on sample plates having a sheet thickness of 4 mm.

Charpy impact resistance was measured at room temperature according to ISO 7391/179eU on single side gate injection molded test bars measuring 80 mm×10 mm×3 mm.

Charpy notched impact resistance was measured at room temperature according to ISO 7391/179eA on single side gate injection molded test bars measuring 80 mm×10 mm×3 mm.

The rheological tests were performed with an MCR 301 cone-and-plate rheometer with a CP 25 measuring cone and the conditions below:

Test method: Oscillation—cone and plate

Frequency: 75 to 0.08 Hz =angular frequency of 471 to 0.5 [l/s]

Deformation: 10%-20 measurement points

Temperatures: 300° C., 280° C. and 260° C.,+−0.3° C.

Modulus of elasticity was measured according to ISO 527 on single side gate injection molded shoulder bars having a core measuring 80×10×4 mm

TABLE 1
Copolycarbonate compositions

| | | Example | | |
|---|---|---|---|---|
| | | 1 | | |
| | | (comparative) | 2 | 3 |
| PC-1 | % | 93.00 | 93.00 | 93.00 |
| PC-2 | % | 7.00 | 6.79 | 6.59 |
| Component B | % | — | 0.20 | 0.40 |
| Component C | % | — | 0.01 | 0.01 |

The % values are wt % values in each case.

TABLE 2
Rheological and thermal properties of the compositions

| | | Example | | |
|---|---|---|---|---|
| | | 1 | | |
| | | (comparative) | 2 | 3 |
| MVR 330° C./2.16 kg | cm³/10 min | 16.0 | 19.7 | 25.6 |
| Melt visc. at 300° C. | | | | |
| eta 50 | Pa · s | 1682 | 1511 | 1341 |
| eta 100 | Pa · s | 1553 | 1416 | 1249 |
| eta 200 | Pa · s | 1346 | 1244 | 1118 |
| eta 500 | Pa · s | 928 | 873 | 791 |
| eta 1000 | Pa · s | 628 | 594 | 542 |
| eta 1500 | Pa · s | 492 | 462 | 421 |
| eta 5000 | Pa · s | 218 | 205 | 189 |
| Melt visc. at 320° C. | | | | |
| eta 50 | Pa · s | 802 | 719 | 684 |
| eta 100 | Pa · s | 764 | 682 | 639 |
| eta 200 | Pa · s | 698 | 628 | 588 |
| eta 500 | Pa · s | 555 | 506 | 478 |
| eta 1000 | Pa · s | 410 | 379 | 361 |
| eta 1500 | Pa · s | 328 | 306 | 292 |
| eta 5000 | Pa · s | 149 | 142 | 137 |
| Melt visc. at 330° C. | | | | |
| eta 50 | Pa · s | 556 | 521 | 439 |
| eta 100 | Pa · s | 541 | 505 | 423 |
| eta 200 | Pa · s | 508 | 472 | 403 |
| eta 500 | Pa · s | 425 | 397 | 344 |
| eta 1000 | Pa · s | 330 | 311 | 276 |
| eta 1500 | Pa · s | 271 | 257 | 236 |
| eta 5000 | Pa · s | 129 | 123 | 117 |
| Melt visc. at 340° C. | | | | |
| eta 50 | Pa · s | 398 | 353 | 310 |
| eta 100 | Pa · s | 383 | 342 | 305 |
| eta 200 | Pa · s | 367 | 331 | 288 |
| eta 500 | Pa · s | 321 | 293 | 255 |
| eta 1000 | Pa · s | 263 | 241 | 215 |
| eta 1500 | Pa · s | 224 | 206 | 186 |
| eta 5000 | Pa · s | 113 | 106 | 99 |
| Melt visc. at 360° C. | | | | |
| eta 50 | Pa · s | 216 | 175 | 151 |
| eta 100 | Pa · s | 214 | 174 | 149 |
| eta 200 | Pa · s | 211 | 171 | 144 |
| eta 500 | Pa · s | 194 | 159 | 135 |
| eta 1000 | Pa · s | 171 | 142 | 123 |
| eta 1500 | Pa · s | 151 | 129 | 110 |
| eta 5000 | Pa · s | 85 | 77 | 74 |
| Vicat VSTB 120 | ° C. | 179.3 | 178.2 | 176.0 |

For virtually identical Vicat temperatures the inventive examples 2 and 3 exhibit significantly higher MVR values which indicate an improved flowability of the melts.

The improved flowabilities are likewise demonstrable for all shear rates over the entire industrial processing range from 300° C. to 360° C.

TABLE 3
Optical properties of the copolycarbonate compositions

| | | Examples | | |
|---|---|---|---|---|
| | | 1 | | |
| optical data | | (comparative) | 2 | 3 |
| 330° C. | | | | |
| Transmission | % | 86.97 | 87.21 | 87.26 |
| Haze | % | 0.49 | 0.64 | 0.53 |
| Y.I. | | 1.82 | 1.41 | 1.42 |
| 360° C. | | | | |
| Transmission | % | 86.97 | 87.2 | 87.2 |
| Haze | % | 0.34 | 0.58 | 0.57 |
| Y.I. | | 2.05 | 1.45 | 1.57 |

In all cases the inventive examples 2 and 3 show a higher transmission coupled with a lower yellowness index (Y.I.) than the comparative example 1.

TABLE 4
Mechanical properties of the copolycarbonate compositions

| | | Examples | | |
|---|---|---|---|---|
| | | 1 | | |
| mechanical properties | | (comparative) | 2 | 3 |
| Impact resistance (Charpy, | kJ/m² | n.b. | n.b. | 9xn.b. |
| ISO 7391/179eU | | | | 1x113 s |
| Notched impact resistance | kJ/m² | 9 s | 7 s | 7 s |
| (Charpy, ISO7391/179eA | | | | |
| Tensile tests (ISO 527) | | | | |
| Yield stress | N/mm² | 73 | 74 | 75 |
| Elongation | % | 6.6 | 6.5 | 6.3 |
| Tear strength | N/mm² | 69 | 70 | 74 |
| Breaking elongation | % | 111 | 118 | 130 |
| Modulus of elasticity | N/mm² | 2415 | 2438 | 2484 |

n.b.: test rod not broken

For virtually identical behavior for the impact resistances the inventive examples 2 and 3 exhibit mechanical properties that are consistently improved over those of comparative example 1.

TABLE 5
(Composition of the compounds of examples 4-9

| | | 4 | | | 7 | | |
|---|---|---|---|---|---|---|---|
| | | (compar- | | | (compar- | | |
| | | ative) | 5 | 6 | ative) | 8 | 9 |
| PC-3 | % | 100 | 99.8 | 99.6 | — | — | — |
| PC-4 | % | — | — | — | 100 | 99.8 | 99.6 |
| POEM | % | — | 0.2 | 0 | — | 0.2 | 0.4 |
| DL-100 | | | | | | | |
| Tg | [° C.] | 164.2 | 162.4 | 160.7 | 181.7 | 182.1 | 179.3 |

The % values are wt % values in each case.

TABLE 6
(Melt viscosity at angular frequency of 471 to 0.503 [Hz]:

| | | 4 | | | 7 | | |
|---|---|---|---|---|---|---|---|
| | | (compar- | | | (compar- | | |
| Example: | | ative) | 5 | 6 | ative) | 8 | 9 |
| Cone/plate | | | | | | | |
| rheology | | | | | | | |
| Cone/plate | | | | | | | |
| Melt visc. | | | | | | | |
| at | | | | | | | |
| 260° C. [Hz] | | | | | | | |
| 471 | Pa · s | 1000 | 796 | 705 | 1240 | 1150 | 975 |
| 329 | Pa · s | 1200 | 980 | 823 | 1680 | 1550 | 1220 |
| 229 | Pa · s | 1420 | 1150 | 933 | 2140 | 1980 | 1450 |
| 160 | Pa · s | 1640 | 1330 | 1040 | 2710 | 2530 | 1690 |
| 112 | Pa · s | 1860 | 1490 | 1130 | 3350 | 3100 | 1910 |
| 77.8 | Pa · s | 2080 | 1640 | 1200 | 4040 | 3700 | 2120 |
| 54.3 | Pa · s | 2280 | 1770 | 1270 | 4790 | 4320 | 2310 |
| 37.9 | Pa · s | 2460 | 1880 | 1320 | 5530 | 4920 | 2460 |
| 26.4 | Pa · s | 2620 | 1960 | 1360 | 6250 | 5460 | 2590 |
| 18.4 | Pa · s | 2750 | 2030 | 1400 | 6910 | 5950 | 2700 |
| 12.9 | Pa · s | 2860 | 2080 | 1410 | 7520 | 6380 | 2780 |
| 8.97 | Pa · s | 2930 | 2120 | 1430 | 8050 | 6740 | 2840 |
| 6.25 | Pa · s | 2990 | 2150 | 1440 | 8490 | 7030 | 2880 |
| 4.36 | Pa · s | 3030 | 2170 | 1450 | 8850 | 7250 | 2910 |
| 3.04 | Pa · s | 3060 | 2180 | 1450 | 9130 | 7410 | 2930 |
| 2.12 | Pa · s | 3080 | 2190 | 1450 | 9340 | 7530 | 2940 |
| 1.48 | Pa · s | 3100 | 2190 | 1450 | 9500 | 7610 | 2940 |
| 1.03 | Pa · s | 3110 | 2190 | 1450 | 9610 | 7670 | 2940 |
| 0.721 | Pa · s | 3110 | 2200 | 1450 | 9670 | 7680 | 2930 |
| 0.503 | Pa · s | 3110 | 2190 | 1450 | 9700 | 7670 | 2900 |
| Melt | | | | | | | |
| visc. at | | | | | | | |
| 280° C. | | | | | | | |
| [Hz] | | | | | | | |
| 471 | Pa · s | 577 | 494 | 353 | 932 | 814 | 486 |
| 329 | Pa · s | 678 | 557 | 383 | 1130 | 960 | 540 |
| 229 | Pa · s | 770 | 613 | 409 | 1330 | 1110 | 590 |
| 160 | Pa · s | 854 | 662 | 431 | 1540 | 1250 | 636 |
| 112 | Pa · s | 928 | 705 | 449 | 1750 | 1400 | 675 |
| 77.8 | Pa · s | 990 | 743 | 463 | 1950 | 1530 | 707 |
| 54.3 | Pa · s | 1040 | 772 | 472 | 2140 | 1650 | 731 |
| 37.9 | Pa · s | 1080 | 794 | 479 | 2310 | 1750 | 749 |
| 26.4 | Pa · s | 1110 | 810 | 483 | 2450 | 1830 | 762 |
| 18.4 | Pa · s | 1140 | 821 | 486 | 2570 | 1890 | 771 |
| 12.9 | Pa · s | 1150 | 829 | 487 | 2670 | 1940 | 776 |
| 8.97 | Pa · s | 1170 | 834 | 487 | 2730 | 1970 | 779 |
| 6.25 | Pa · s | 1170 | 837 | 487 | 2790 | 2000 | 780 |
| 4.36 | Pa · s | 1180 | 838 | 486 | 2820 | 2010 | 780 |
| 3.04 | Pa · s | 1180 | 840 | 486 | 2850 | 2020 | 779 |
| 2.12 | Pa · s | 1180 | 840 | 484 | 2860 | 2020 | 777 |
| 1.48 | Pa · s | 1190 | 841 | 483 | 2870 | 2030 | 775 |
| 1.03 | Pa · s | 1190 | 842 | 482 | 2870 | 2020 | 772 |
| 0.721 | Pa · s | 1190 | 842 | 481 | 2870 | 2020 | 769 |
| 0.503 | Pa · s | 1190 | 840 | 479 | 2870 | 2010 | 764 |
| Melt | | | | | | | |
| visc. at | | | | | | | |
| 300° C. | | | | | | | |
| [Hz] | | | | | | | |
| 471 | Pa · s | 347 | 258 | 171 | 598 | 481 | 224 |
| 329 | Pa · s | 378 | 275 | 179 | 689 | 537 | 240 |
| 229 | Pa · s | 406 | 291 | 186 | 773 | 590 | 255 |
| 160 | Pa · s | 430 | 304 | 192 | 848 | 637 | 266 |
| 112 | Pa · s | 450 | 314 | 196 | 915 | 679 | 275 |
| 77.8 | Pa · s | 465 | 321 | 199 | 972 | 713 | 282 |
| 54.3 | Pa · s | 477 | 327 | 201 | 1020 | 740 | 287 |
| 37.9 | Pa · s | 486 | 331 | 202 | 1050 | 760 | 291 |
| 26.4 | Pa · s | 492 | 333 | 202 | 1080 | 775 | 293 |
| 18.4 | Pa · s | 497 | 334 | 202 | 1100 | 784 | 294 |
| 12.9 | Pa · s | 499 | 335 | 202 | 1110 | 789 | 295 |
| 8.97 | Pa · s | 501 | 335 | 202 | 1120 | 792 | 295 |
| 6.25 | Pa · s | 503 | 336 | 202 | 1120 | 793 | 295 |
| 4.36 | Pa · s | 504 | 336 | 202 | 1130 | 794 | 295 |
| 3.04 | Pa · s | 505 | 336 | 202 | 1130 | 794 | 295 |
| 2.12 | Pa · s | 505 | 336 | 202 | 1130 | 793 | 295 |
| 1.48 | Pa · s | 506 | 337 | 202 | 1130 | 792 | 296 |
| 1.03 | Pa · s | 508 | 338 | 203 | 1130 | 792 | 296 |
| 0.721 | Pa · s | 509 | 340 | 204 | 1120 | 791 | 297 |
| 0.503 | Pa · s | 510 | 341 | 205 | 1120 | 789 | 299 |

Table 6 shows that compared to the inventive examples 5, 6 and 9 the comparative examples 4 and 7 which do not comprise the flow assistant exhibit higher melt viscosities at the three measurement temperatures and thus have poorer flowability.

TABLE 7
Composition of the copolycarbonates PC-5 to PC-11

| Co- | | | | | | | |
|---|---|---|---|---|---|---|---|
| poly- | | | | | | | |
| carbonate | | | | | | | |
| no. | | | | | | | |
| based | | | | | | | |
| on: | PC-5 | PC-6 | PC-7 | PC-8 | PC-9 | PC-10 | PC-11 |
| Bisphenol | 77.93 | 78.5 | 77.5 | 76.5 | 80 | 80 | 80 |
| according | 70.9 | 71.6 | 70.4 | 69.2 | 73.4 | 73.4 | 73.4 |
| to | | | | | | | |
| formula | | | | | | | |
| (lb’) | | | | | | | |
| where | | | | | | | |
| R³ = | | | | | | | |
| methyl | | | | | | | |
| [mol %] | | | | | | | |
| [wt %] | | | | | | | |
| Bisphenol | 22.07 | 21.5 | 22.5 | 23.5 | 20 | 20 | 20 |
| A (BPA) | 29.1 | 28.4 | 29.6 | 30.8 | 26.6 | 26.6 | 26.6 |
| [mol %] | | | | | | | |
| [wt %] | | | | | | | |
| Glass | 179.4 | 179.6 | 179.6 | 182.3 | 175.3 | 176.1 | 173.9 |
| transition | | | | | | | |
| temper- | | | | | | | |
| ature | | | | | | | |
| Tg [° C.] | | | | | | | |
| ηᵣₑₗ | — | 1.234 | 1.225 | 1.237 | 1.216 | 1.228 | 1.218 |

TABLE 8
(Composition of the compounds of examples 10-30):

| | | | | | | | | POEM | |
|---|---|---|---|---|---|---|---|---|---|
| | | | | | | | | DL- | Tg |
| Example | PC-5% | PC-6% | PC-7% | PC-8% | PC-9% | PC-10% | PC-11% | 100% | ° C. |
| 10 | 100 | | | | | | | | 179.4 |
| (comparative) | | | | | | | | | |
| 11 | 99.8 | | | | | | | 0.2 | 178.7 |
| 12 | 99.6 | | | | | | | 0.4 | 172.4 |
| 13 | | 100 | | | | | | | 179.6 |
| (comparative) | | | | | | | | | |
| 14 | | 99.8 | | | | | | 0.2 | 175.1 |
| 15 | | 99.6 | | | | | | 0.4 | 168.6 |
| 16 | | | 100 | | | | | | 179.6 |
| (comparative) | | | | | | | | | |
| 17 | | | 99.8 | | | | | 0.2 | 177.3 |
| 18 | | | 99.6 | | | | | 0.4 | 169.5 |
| 19 | | | | 100 | | | | | 182.3 |
| (comparative) | | | | | | | | | |
| 20 | | | | 99.8 | | | | 0.2 | 179.3 |
| 21 | | | | 99.6 | | | | 0.4 | 171.9 |
| 22 | | | | | 100 | | | | 175.3 |
| (comparative) | | | | | | | | | |
| 23 | | | | | 99.8 | | | 0.2 | 175.2 |
| 24 | | | | | 99.6 | | | 0.4 | 171.3 |
| 25 | | | | | | 100 | | | 176.1 |
| (comparative) | | | | | | | | | |
| 26 | | | | | | 99.8 | | 0.2 | 171.5 |
| 27 | | | | | | 99.6 | | 0.4 | 168.6 |
| 28 | | | | | | | 100 | | 173.9 |
| (comparative) | | | | | | | | | |
| 29 | | | | | | | 99.8 | 0.2 | 171.9 |
| 30 | | | | | | | 99.6 | 0.4 | 167.3 |

The % values are wt % values in each case.

TABLE 9
(Melt viscosity at angular frequency of 471 to 0.503 [Hz]

| | | 10 | | | 13 | | |
|---|---|---|---|---|---|---|---|
| | | (compar- | | | (compar- | | |
| Example | | ative) | 11 | 12 | ative) | 14 | 15 |
| Cone/plate | | | | | | | |
| rheology | | | | | | | |
| Melt visc. | | | | | | | |
| at 260° C. [Hz] | | | | | | | |
| 471 | Pa · s | 835 | 938 | 441 | 441 | 938 | 356 |
| 329 | Pa · s | 1120 | 1210 | 494 | 494 | 1100 | 390 |
| 229 | Pa · s | 1400 | 1490 | 548 | 548 | 1280 | 423 |
| 160 | Pa · s | 1720 | 1820 | 597 | 597 | 1480 | 453 |
| 112 | Pa · s | 2050 | 2160 | 641 | 641 | 1680 | 479 |
| 77.8 | Pa · s | 2360 | 2460 | 679 | 679 | 1870 | 501 |
| 54.3 | Pa · s | 2640 | 2720 | 712 | 712 | 2050 | 520 |
| 37.9 | Pa · s | 2910 | 2970 | 739 | 739 | 2210 | 537 |
| 26.4 | Pa · s | 3140 | 3190 | 763 | 763 | 2350 | 555 |
| 18.4 | Pa · s | 3350 | 3390 | 783 | 783 | 2470 | 565 |
| 12.9 | Pa · s | 3520 | 3550 | 802 | 802 | 2570 | 578 |
| 8.97 | Pa · s | 3660 | 3690 | 820 | 820 | 2650 | 592 |
| 6.25 | Pa · s | 3780 | 3800 | 839 | 839 | 2720 | 607 |
| 4.36 | Pa · s | 3870 | 3890 | 858 | 858 | 2770 | 624 |
| 3.04 | Pa · s | 3940 | 3960 | 879 | 879 | 2810 | 642 |
| 2.12 | Pa · s | 3980 | 4000 | 898 | 898 | 2840 | 660 |
| 1.48 | Pa · s | 4020 | 4040 | 918 | 918 | 2870 | 680 |
| 1.03 | Pa · s | 4050 | 4080 | 936 | 936 | 2900 | 700 |
| 0.721 | Pa · s | 4060 | 4100 | 955 | 955 | 2920 | 720 |
| 0.503 | Pa · s | 4070 | 4110 | 975 | 975 | 2950 | 740 |
| Melt visc. | | | | | | | |
| at 280° C. [Hz] | | | | | | | |
| 471 | Pa · s | 545 | 612 | 197 | 679 | 493 | 155 |
| 329 | Pa · s | 660 | 701 | 210 | 772 | 553 | 163 |
| 229 | Pa · s | 752 | 788 | 221 | 865 | 611 | 170 |
| 160 | Pa · s | 832 | 869 | 231 | 952 | 665 | 176 |
| 112 | Pa · s | 906 | 943 | 238 | 1030 | 713 | 181 |
| 77.8 | Pa · s | 973 | 1010 | 245 | 1100 | 756 | 185 |
| 54.3 | Pa · s | 1030 | 1060 | 250 | 1160 | 791 | 189 |
| 37.9 | Pa · s | 1080 | 1110 | 255 | 1210 | 820 | 193 |
| 26.4 | Pa · s | 1120 | 1150 | 259 | 1250 | 843 | 197 |
| 18.4 | Pa · s | 1150 | 1180 | 263 | 1290 | 861 | 200 |
| 12.9 | Pa · s | 1170 | 1200 | 267 | 1310 | 874 | 204 |
| 8.97 | Pa · s | 1190 | 1220 | 271 | 1320 | 884 | 208 |
| 6.25 | Pa · s | 1200 | 1230 | 275 | 1330 | 892 | 212 |
| 4.36 | Pa · s | 1210 | 1240 | 279 | 1340 | 899 | 217 |
| 3.04 | Pa · s | 1210 | 1240 | 284 | 1350 | 906 | 222 |
| 2.12 | Pa · s | 1220 | 1250 | 289 | 1350 | 912 | 227 |
| 1.48 | Pa · s | 1220 | 1250 | 296 | 1350 | 919 | 233 |
| 1.03 | Pa · s | 1220 | 1250 | 305 | 1350 | 929 | 240 |
| 0.721 | Pa · s | 1230 | 1260 | 316 | 1350 | 940 | 248 |
| 0.503 | Pa · s | 1230 | 1260 | 330 | 1350 | 954 | 258 |
| Melt visc. | | | | | | | |
| at 300° C. [Hz] | | | | | | | |
| 471 | Pa · s | 332 | 341 | 102 | 376 | 267 | 74.6 |
| 329 | Pa · s | 363 | 370 | 104 | 409 | 287 | 76.4 |
| 229 | Pa · s | 392 | 396 | 105 | 439 | 305 | 77.8 |
| 160 | Pa · s | 418 | 419 | 106 | 465 | 320 | 79 |
| 112 | Pa · s | 439 | 438 | 107 | 486 | 332 | 80 |
| 77.8 | Pa · s | 457 | 453 | 107 | 503 | 342 | 80.8 |
| 54.3 | Pa · s | 471 | 465 | 107 | 516 | 349 | 81.7 |
| 37.9 | Pa · s | 481 | 474 | 107 | 526 | 354 | 82.5 |
| 26.4 | Pa · s | 488 | 480 | 108 | 533 | 358 | 83.7 |
| 18.4 | Pa · s | 492 | 485 | 108 | 538 | 361 | 84.2 |
| 12.9 | Pa · s | 496 | 488 | 108 | 541 | 363 | 85.2 |
| 8.97 | Pa · s | 497 | 490 | 109 | 542 | 365 | 86.3 |
| 6.25 | Pa · s | 497 | 492 | 110 | 543 | 367 | 87.8 |
| 4.36 | Pa · s | 497 | 494 | 112 | 544 | 369 | 89.4 |
| 3.04 | Pa · s | 497 | 495 | 115 | 546 | 372 | 91.6 |
| 2.12 | Pa · s | 496 | 496 | 119 | 545 | 375 | 94.2 |
| 1.48 | Pa · s | 496 | 497 | 124 | 546 | 380 | 97.6 |
| 1.03 | Pa · s | 496 | 499 | 131 | 545 | 388 | 102 |
| 0.721 | Pa · s | 496 | 502 | 138 | 545 | 398 | 107 |
| 0.503 | Pa · s | 497 | 504 | 147 | 544 | 412 | 113 |
| | | 16 | | | 19 | | |
| | | (compar- | | | (compar- | | |
| Example | | ative) | 17 | 18 | ative) | 20 | 21 |
| Cone/plate | | | | | | | |
| rheology | | | | | | | |
| Melt visc. | | | | | | | |
| at 260° C. [Hz] | | | | | | | |
| 471 | Pa · s | 1240 | 946 | 253 | 1310 | 969 | 329 |
| 329 | Pa · s | 1490 | 1110 | 269 | 1610 | 1150 | 352 |
| 229 | Pa · s | 1760 | 1290 | 282 | 1950 | 1340 | 371 |
| 160 | Pa · s | 2050 | 1500 | 292 | 2310 | 1570 | 387 |
| 112 | Pa · s | 2360 | 1710 | 300 | 2710 | 1830 | 399 |
| 77.8 | Pa · s | 2680 | 1910 | 305 | 3130 | 2110 | 408 |
| 54.3 | Pa · s | 2990 | 2110 | 309 | 3550 | 2360 | 414 |
| 37.9 | Pa · s | 3280 | 2280 | 311 | 3960 | 2600 | 418 |
| 26.4 | Pa · s | 3540 | 2430 | 314 | 4340 | 2810 | 422 |
| 18.4 | Pa · s | 3770 | 2570 | 315 | 4680 | 3000 | 424 |
| 12.9 | Pa · s | 3960 | 2680 | 315 | 4980 | 3160 | 425 |
| 8.97 | Pa · s | 4130 | 2770 | 316 | 5240 | 3290 | 427 |
| 6.25 | Pa · s | 4260 | 2850 | 317 | 5460 | 3410 | 429 |
| 4.36 | Pa · s | 4360 | 2910 | 317 | 5630 | 3500 | 430 |
| 3.04 | Pa · s | 4450 | 2970 | 319 | 5760 | 3580 | 431 |
| 2.12 | Pa · s | 4500 | 3010 | 320 | 5870 | 3650 | 431 |
| 1.48 | Pa · s | 4550 | 3060 | 323 | 5960 | 3710 | 433 |
| 1.03 | Pa · s | 4580 | 3100 | 328 | 6020 | 3760 | 434 |
| 0.721 | Pa · s | 4610 | 3140 | 335 | 6060 | 3800 | 435 |
| 0.503 | Pa · s | 4620 | 3160 | 343 | 6090 | 3830 | 436 |
| Melt visc. | | | | | | | |
| at 280° C. [Hz] | | | | | | | |
| 471 | Pa · s | 666 | 545 | 98.7 | 730 | 514 | 105 |
| 329 | Pa · s | 758 | 614 | 102 | 845 | 583 | 108 |
| 229 | Pa · s | 850 | 681 | 104 | 968 | 656 | 110 |
| 160 | Pa · s | 940 | 743 | 106 | 1090 | 725 | 112 |
| 112 | Pa · s | 1020 | 799 | 107 | 1200 | 789 | 113 |
| 77.8 | Pa · s | 1100 | 848 | 108 | 1300 | 845 | 113 |
| 54.3 | Pa · s | 1160 | 888 | 109 | 1390 | 894 | 114 |
| 37.9 | Pa · s | 1220 | 921 | 109 | 1470 | 936 | 114 |
| 26.4 | Pa · s | 1260 | 946 | 110 | 1540 | 970 | 115 |
| 18.4 | Pa · s | 1300 | 965 | 111 | 1590 | 997 | 115 |
| 12.9 | Pa · s | 1320 | 979 | 111 | 1630 | 1020 | 115 |
| 8.97 | Pa · s | 1340 | 989 | 112 | 1660 | 1040 | 116 |
| 6.25 | Pa · s | 1360 | 995 | 114 | 1680 | 1050 | 117 |
| 4.36 | Pa · s | 1370 | 1000 | 116 | 1700 | 1060 | 118 |
| 3.04 | Pa · s | 1370 | 1010 | 119 | 1710 | 1070 | 119 |
| 2.12 | Pa · s | 1380 | 1010 | 123 | 1720 | 1080 | 121 |
| 1.48 | Pa · s | 1380 | 1010 | 128 | 1730 | 1090 | 125 |
| 1.03 | Pa · s | 1390 | 1020 | 135 | 1740 | 1100 | 129 |
| 0.721 | Pa · s | 1390 | 1020 | 144 | 1740 | 1110 | 134 |
| 0.503 | Pa · s | 1390 | 1030 | 154 | 1740 | 1120 | 140 |
| Melt visc. | | | | | | | |
| at 300° C. [Hz] | | | | | | | |
| 471 | Pa · s | 369 | 265 | 59.1 | 59.1 | 279 | 41.3 |
| 329 | Pa · s | 402 | 285 | 60.3 | 60.3 | 303 | 41.3 |
| 229 | Pa · s | 433 | 303 | 61.2 | 61.2 | 325 | 41.2 |
| 160 | Pa · s | 460 | 318 | 62.1 | 62.1 | 343 | 41.1 |
| 112 | Pa · s | 482 | 330 | 62.9 | 62.9 | 359 | 41.1 |
| 77.8 | Pa · s | 501 | 340 | 63.7 | 63.7 | 371 | 41.1 |
| 54.3 | Pa · s | 515 | 347 | 64.6 | 64.6 | 381 | 41.1 |
| 37.9 | Pa · s | 526 | 353 | 65.6 | 65.6 | 389 | 41.3 |
| 26.4 | Pa · s | 535 | 358 | 66.7 | 66.7 | 394 | 41.6 |
| 18.4 | Pa · s | 540 | 361 | 67.8 | 67.8 | 398 | 42.1 |
| 12.9 | Pa · s | 544 | 364 | 68.9 | 68.9 | 401 | 42.9 |
| 8.97 | Pa · s | 546 | 366 | 70.3 | 70.3 | 403 | 44 |
| 6.25 | Pa · s | 547 | 368 | 71.8 | 71.8 | 405 | 45.7 |
| 4.36 | Pa · s | 548 | 370 | 73.8 | 73.8 | 408 | 48 |
| 3.04 | Pa · s | 549 | 373 | 76.3 | 76.3 | 411 | 50.8 |
| 2.12 | Pa · s | 549 | 375 | 79.3 | 79.3 | 414 | 54.1 |
| 1.48 | Pa · s | 550 | 378 | 83 | 83 | 419 | 58.1 |
| 1.03 | Pa · s | 551 | 383 | 87.6 | 87.6 | 426 | 62.7 |
| 0.721 | Pa · s | 551 | 388 | 93.5 | 93.5 | 437 | 68 |
| 0.503 | Pa · s | 552 | 395 | 101 | 101 | 451 | 74.1 |
| | | 22 | | | 25 | | |
| | | (compar- | | | (compar- | | |
| Example | | ative) | 23 | 24 | ative) | 26 | 27 |
| Cone/plate | | | | | | | |
| rheology | | | | | | | |
| Melt visc. | | | | | | | |
| at 260° C. [Hz] | | | | | | | |
| 471 | Pa · s | 1320 | 1030 | 731 | 946 | 380 | 268 |
| 329 | Pa · s | 1620 | 1220 | 834 | 1120 | 413 | 286 |
| 229 | Pa · s | 1940 | 1420 | 935 | 1300 | 444 | 302 |
| 160 | Pa · s | 2290 | 1630 | 1030 | 1480 | 471 | 315 |
| 112 | Pa · s | 2670 | 1830 | 1120 | 1670 | 493 | 325 |
| 77.8 | Pa · s | 3050 | 2030 | 1190 | 1840 | 511 | 332 |
| 54.3 | Pa · s | 3430 | 2210 | 1260 | 2010 | 525 | 338 |
| 37.9 | Pa · s | 3790 | 2370 | 1310 | 2160 | 535 | 342 |
| 26.4 | Pa · s | 4120 | 2510 | 1350 | 2290 | 542 | 344 |
| 18.4 | Pa · s | 4430 | 2630 | 1390 | 2400 | 547 | 346 |
| 12.9 | Pa · s | 4700 | 2730 | 1410 | 2500 | 551 | 348 |
| 8.97 | Pa · s | 4920 | 2810 | 1430 | 2570 | 555 | 350 |
| 6.25 | Pa · s | 5110 | 2860 | 1450 | 2630 | 557 | 351 |
| 4.36 | Pa · s | 5250 | 2900 | 1460 | 2680 | 559 | 353 |
| 3.04 | Pa · s | 5360 | 2930 | 1470 | 2710 | 561 | 356 |
| 2.12 | Pa · s | 5440 | 2940 | 1470 | 2730 | 563 | 359 |
| 1.48 | Pa · s | 5500 | 2960 | 1470 | 2750 | 567 | 365 |
| 1.03 | Pa · s | 5540 | 2960 | 1470 | 2760 | 571 | 374 |
| 0.721 | Pa · s | 5550 | 2960 | 1470 | 2770 | 577 | 387 |
| 0.503 | Pa · s | 5550 | 2950 | 1460 | 2770 | 584 | 407 |
| Melt visc. | | | | | | | |
| at 280° C. [Hz] | | | | | | | |
| 471 | Pa · s | 736 | 525 | 394 | 379 | 146 | 95.1 |
| 329 | Pa · s | 846 | 585 | 431 | 100 | 152 | 97.6 |
| 229 | Pa · s | 958 | 644 | 464 | 458 | 157 | 99.4 |
| 160 | Pa · s | 1070 | 697 | 493 | 494 | 161 | 101 |
| 112 | Pa · s | 1170 | 746 | 518 | 525 | 164 | 102 |
| 77.8 | Pa · s | 1270 | 787 | 538 | 553 | 166 | 102 |
| 54.3 | Pa · s | 1360 | 822 | 553 | 576 | 168 | 103 |
| 37.9 | Pa · s | 1430 | 850 | 565 | 596 | 169 | 103 |
| 26.4 | Pa · s | 1490 | 871 | 574 | 613 | 171 | 104 |
| 18.4 | Pa · s | 1540 | 887 | 579 | 623 | 172 | 104 |
| 12.9 | Pa · s | 1580 | 899 | 583 | 632 | 173 | 104 |
| 8.97 | Pa · s | 1610 | 906 | 584 | 639 | 174 | 104 |
| 6.25 | Pa · s | 1630 | 911 | 585 | 645 | 175 | 105 |
| 4.36 | Pa · s | 1650 | 915 | 586 | 650 | 177 | 106 |
| 3.04 | Pa · s | 1660 | 917 | 586 | 656 | 179 | 107 |
| 2.12 | Pa · s | 1660 | 917 | 585 | 660 | 181 | 109 |
| 1.48 | Pa · s | 1660 | 917 | 584 | 665 | 185 | 112 |
| 1.01 | Pa · s | 1660 | 917 | 583 | 670 | 190 | 115 |
| 0.721 | Pa · s | 1660 | 917 | 581 | 675 | 195 | 119 |
| 0.503 | Pa · s | 1650 | 915 | 578 | 679 | 202 | 125 |
| Melt visc. | | | | | | | |
| at 300° C. [Hz] | | | | | | | |
| 471 | Pa · s | 391 | 231 | 161 | 243 | 58.4 | 42.2 |
| 329 | Pa · s | 428 | 247 | 168 | 260 | 59.8 | 42.7 |
| 229 | Pa · s | 463 | 261 | 174 | 276 | 60.9 | 43.1 |
| 160 | Pa · s | 495 | 272 | 179 | 291 | 61.9 | 43.4 |
| 112 | Pa · s | 522 | 282 | 183 | 303 | 62.8 | 43.8 |
| 77.8 | Pa · s | 544 | 289 | 185 | 312 | 63.6 | 44.2 |
| 54.3 | Pa · s | 563 | 294 | 187 | 320 | 64.5 | 44.6 |
| 37.9 | Pa · s | 577 | 298 | 188 | 326 | 65.5 | 45.2 |
| 26.4 | Pa · s | 588 | 301 | 188 | 331 | 66.7 | 45.9 |
| 18.4 | Pa · s | 595 | 302 | 188 | 335 | 68.1 | 46.9 |
| 12.9 | Pa · s | 599 | 304 | 188 | 338 | 69.7 | 48.3 |
| 8.97 | Pa · s | 603 | 304 | 188 | 342 | 71.9 | 50.1 |
| 6.25 | Pa · s | 604 | 304 | 188 | 344 | 74.3 | 52.5 |
| 4.36 | Pa · s | 605 | 304 | 187 | 346 | 77.2 | 55.5 |
| 3.04 | Pa · s | 604 | 304 | 188 | 349 | 80.8 | 59.2 |
| 2.12 | Pa · s | 603 | 304 | 188 | 352 | 84.9 | 63.4 |
| 1.48 | Pa · s | 602 | 305 | 188 | 356 | 89.8 | 68.4 |
| 1.03 | Pa · s | 600 | 306 | 190 | 361 | 95.5 | 74 |
| 0.721 | Pa · s | 598 | 307 | 191 | 368 | 102 | 80.6 |
| 0.503 | Pa · s | 594 | 308 | 194 | 375 | 110 | 88.1 |

| | | 28 | | 30 |
|---|---|---|---|---|
| | | (compar- | | (compar- |
| Example | | ative) | 29 | ative) |
| Cone/plate | | | | |
| rheology | | | | |
| Melt visc. | | | | |
| at 260° C. [Hz] | | | | |
| 471 | Pa · s | 831 | 789 | 315 |
| 329 | Pa · s | 972 | 918 | 342 |
| 229 | Pa · s | 1120 | 1050 | 367 |
| 160 | Pa · s | 1260 | 1170 | 388 |
| 112 | Pa · s | 1390 | 1300 | 405 |
| 77.8 | Pa · s | 1520 | 1410 | 418 |
| 54.3 | Pa · s | 1640 | 1510 | 428 |
| 37.9 | Pa · s | 1740 | 1590 | 436 |
| 26.4 | Pa · s | 1820 | 1660 | 441 |
| 18.4 | Pa · s | 1890 | 1720 | 444 |
| 12.9 | Pa · s | 1950 | 1760 | 446 |
| 8.97 | Pa · s | 1990 | 1800 | 449 |
| 6.25 | Pa · s | 2030 | 1820 | 450 |
| 4.36 | Pa · s | 2050 | 1840 | 451 |
| 3.04 | Pa · s | 2060 | 1850 | 454 |
| 2.12 | Pa · s | 2070 | 1850 | 456 |
| 1.48 | Pa · s | 2080 | 1860 | 460 |
| 1.03 | Pa · s | 2090 | 1860 | 467 |
| 0.721 | Pa · s | 2100 | 1860 | 476 |
| 0.503 | Pa · s | 2100 | 1860 | 489 |
| Melt visc. | | | | |
| at 280° C. [Hz] | | | | |
| 471 | Pa · s | 379 | 377 | 145 |
| 329 | Pa · s | 414 | 415 | 152 |
| 229 | Pa · s | 446 | 450 | 158 |
| 160 | Pa · s | 475 | 482 | 163 |
| 112 | Pa · s | 500 | 509 | 166 |
| 77.8 | Pa · s | 520 | 532 | 169 |
| 54.3 | Pa · s | 537 | 550 | 171 |
| 37.9 | Pa · s | 550 | 564 | 173 |
| 26.4 | Pa · s | 560 | 574 | 175 |
| 18.4 | Pa · s | 567 | 582 | 177 |
| 12.9 | Pa · s | 572 | 586 | 178 |
| 8.97 | Pa · s | 575 | 589 | 180 |
| 6.25 | Pa · s | 577 | 591 | 182 |
| 4.36 | Pa · s | 578 | 592 | 185 |
| 3.04 | Pa · s | 580 | 594 | 189 |
| 2.12 | Pa · s | 581 | 594 | 193 |
| 1.48 | Pa · s | 583 | 596 | 200 |
| 1.03 | Pa · s | 586 | 597 | 208 |
| 0.721 | Pa · s | 589 | 600 | 217 |
| 0.503 | Pa · s | 592 | 602 | 228 |
| Melt visc. | | | | |
| at 300° C. [Hz] | | | | |
| 471 | Pa · s | 279 | 189 | 63.5 |
| 329 | Pa · s | 301 | 201 | 65 |
| 229 | Pa · s | 321 | 211 | 66.1 |
| 160 | Pa · s | 338 | 219 | 67.1 |
| 112 | Pa · s | 353 | 226 | 67.9 |
| 77.8 | Pa · s | 365 | 231 | 68.6 |
| 54.3 | Pa · s | 375 | 235 | 69.3 |
| 37.9 | Pa · s | 382 | 237 | 70.1 |
| 26.4 | Pa · s | 388 | 239 | 70.9 |
| 18.4 | Pa · s | 393 | 241 | 72 |
| 12.9 | Pa · s | 397 | 242 | 73.4 |
| 8.97 | Pa · s | 399 | 243 | 75.3 |
| 6.25 | Pa · s | 402 | 244 | 77.8 |
| 4.36 | Pa · s | 403 | 245 | 81.1 |
| 3.04 | Pa · s | 405 | 247 | 85.4 |
| 2.12 | Pa · s | 407 | 249 | 90.5 |
| 1.48 | Pa · s | 410 | 254 | 96.6 |
| 1.03 | Pa · s | 412 | 260 | 104 |
| 0.721 | Pa · s | 417 | 268 | 111 |
| 0.503 | Pa · s | 420 | 277 | 120 |

Table 9 shows that compared to the inventive examples 11-12, 14-15, 17-18, 20-21, 23-24, 26-27 and 29-30 the comparative examples 10, 13, 16, 19, 22, 25 and 28 which do not comprise the diglycerol ester in each case exhibit higher melt viscosities in the table at the three measurement temperatures and thus have poorer flowability.

1.-15. (canceled)

16. A composition comprising
A) 67.0 to 99.95 wt % of one or more copolycarbonates comprising monomer units selected from the group consisting of the structural units of general formulae (1a), (1b), (1c) and (1d) 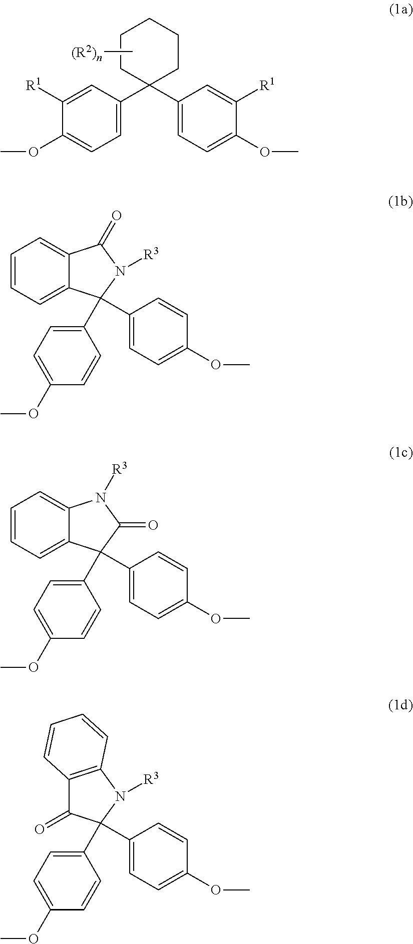
in which
R¹ represents hydrogen or C₁-C₄-alkyl,
R² represents C₁-C₄-alkyl,
n represents 0, 1, 2 or 3 and
R³ represents C₁-C₄-alkyl, aralkyl or aryl,
Or
67.0 to 99.95 wt % of a blend of the one or more copolycarbonates and at least one further homo- or copolycarbonate comprising one or more monomer units of general formula (2): 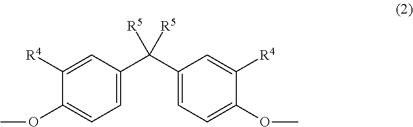
in which
R⁴ represents H, linear or branched C₁-C₁₀ alkyl and
R⁵ represents linear or branched C₁-C₁₀ alkyl;
wherein the optionally present further homo- or copolycarbonate has no monomer units of formulae (1a), (1b), (1c) and (1d);
B) 0.05 to 3.0 wt % of at least one diglycerol ester; and
C) optionally one or more added substances in a total amount of up to 30.0 wt %.

17. The composition as claimed in claim 16, wherein the diglycerol ester is derived from a saturated or unsaturated monocarboxylic acid having a chain length of 6 to 30 carbon atoms.

18. The composition as claimed in claim 16, wherein the composition comprises as component B) a diglycerol ester of formula (I) or a mixture of different diglycerol esters of formula (I) 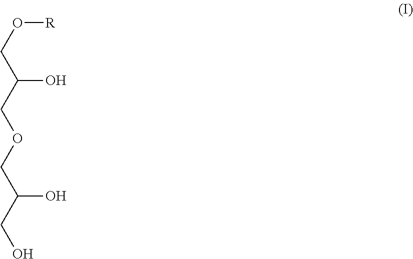
in which
R represents COCₙH₂ₙ₊₁ or COR′,
R′ is a branched alkyl radical or a branched or unbranched alkenyl radical,
CₙH₂ₙ₊₁ is an aliphatic, saturated linear alkyl radical and
n represents an integer from 6 to 24.

19. The composition as claimed in claim 16, wherein the diglycerol ester is derived from a carboxylic acid selected from the group consisting of caprylic acid, capric acid, lauric acid, myristic acid, palmitic acid, margaric acid, stearic acid, arachidic acid, behenic acid, lignoceric acid, palmitoleic acid, petroselic acid, oleic acid, elaidic acid, linoleic acid, linolenic acid, arachidonic acid, timnodonic acid and cervonic acid.

20. The composition as claimed in claim 16, wherein the diglycerol ester has an HLB value of 6 to 12.

21. The composition as claimed in claim 16, wherein the amount of diglycerol ester is 0.10 to 2.0 wt %.

22. The composition as claimed in claim 16, wherein the total proportion of the monomer units of formulae (1a), (1 b), (1c) and (1d) in the copolycarbonate is 0.1-88 mol % (based on the sum of the diphenol monomer units present therein).

23. The composition as claimed in claim 16, wherein the composition comprises the one or more copolycarbonates comprising the monomer units of formulae (1a), (1 b), (1c) and/or (1d) in an amount of at least 60 wt %.

24. The composition as claimed in claim 16, wherein the copolycarbonate comprising the monomer units of formulae (1a), (1b), (1c) and/or (1d) further comprises monomer units of formula (3) 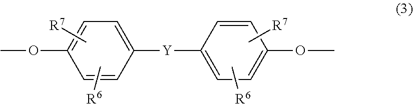
in which
R⁶ and R⁷ independently of one another represent H, C₁-C₁₈-alkyl-, C₁-C₁₈-alkoxy, halogen such as Cl or Br or respectively optionally substituted aryl or aralkyl and Y represents a single bond, —SO₂—, —CO—, —O—, —S—, C₁-C₆-alkylene or C₂-C₅-alkylidene, furthermore C₆-C₁₂-arylene, which may optionally be fused with further heteroatom—comprising aromatic rings.

25. The composition as claimed in claim 16, wherein the copolycarbonate comprises monomer units derived from compounds of general formulae (1a″), (1b′), (1 c′) and/or (1 d′) in combination with monomer units derived from compounds of general formula (3c). 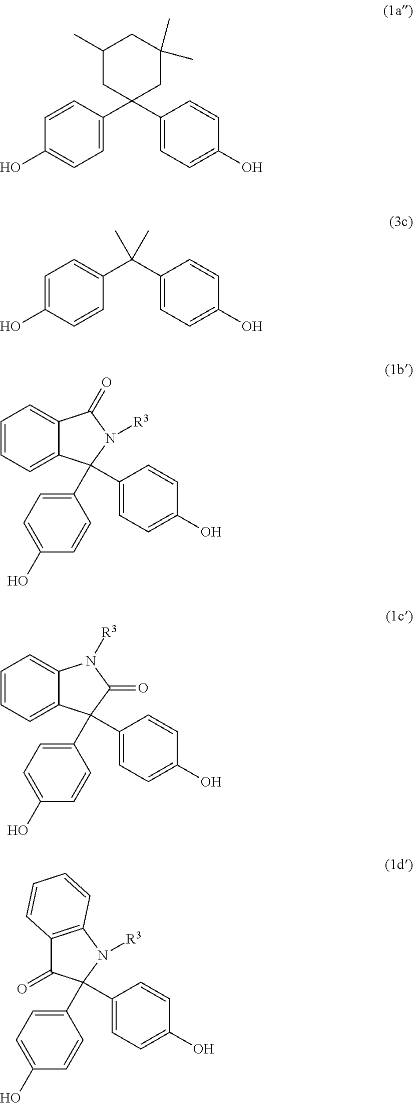
wherein R³ is methyl or phenyl.

26. The composition as claimed in claim 16, wherein the composition comprises as component A) a blend of the copolycarbonate and the further homo- or copolycarbonate comprising one or more monomer units of general formula (2), wherein R⁴ represents H and R⁵ represents linear or branched C₁-C₆ alkyl.

27. The composition as claimed in claim 16, wherein the composition comprises one or more additives selected from the group consisting of thermal stabilizers, demolding agents and UV stabilizers.

28. The composition as claimed in claim 16, wherein the composition comprises 0.002 to 0.2 wt % of thermal stabilizer, 0.01 wt % to 1.00 wt % of UV stabilizer and 0.05 wt % to 2.00 wt % of demolding agent.

29. A blend, molding, extrudate, film or film laminate obtainable from copolycarbonate compositions as claimed in claim 16 or else a molding, extrudate or film comprising coextrusion layers obtainable from copolycarbonate compositions as claimed in claim 16.

30. A method comprising utilizing at least one diglycerol ester for improving the breaking elongation and/or for reducing the yellowness index of compositions comprising a copolycarbonate as claimed in claim 16 or a blend of the copolycarbonate and a further homo- or copolycarbonate as claimed in claim 16.
